(19) United States
(12) Patent Application Publication
(10) Pub. No.: US 2012/0253830 A1
(43) Pub. Date: Oct. 4, 2012

(54) SYSTEMS AND METHODS FOR VARIABLE CUSTOMER PRICING FOR VIRTUAL PHARMACIES

(75) Inventors: Pramod John, Hayward, CA (US); Sean Gallacher, Walnut Creek, CA (US); Rick Reddy, Capitola, CA (US); David Silverberg, Larkspur, CA (US)

(73) Assignee: MCKESSON CORPORATION, San Francisco, CA (US)

(21) Appl. No.: 13/075,991

(22) Filed: Mar. 30, 2011

(51) Int. Cl. G06Q 50/00; G06Q 30/00

(52) U.S. Cl. 705/2

(57) ABSTRACT

Systems and methods may be provided for interactive virtual pharmacies. The systems and methods may include receiving, by a non-dispensing virtual pharmacy comprising one or more computers, an electronic prescription associated with a patient, where the electronic prescription is associated with at least one drug or product prescribed for the patient; determining, by the non-dispensing virtual pharmacy, a respective total price payable to each of the plurality of dispensing pharmacies for filling the prescription for the patient; determining, by the non-dispensing virtual pharmacy based upon the determined respective total price, a respective patient payable amount for filling the prescription at each of the plurality of dispensing pharmacies; and delivering, in real-time from the non-dispensing virtual pharmacy to a patient device, an identification of the plurality of dispensing pharmacies and the respective patient payment amount at each dispensing pharmacy.

### FIELD OF THE INVENTION

Aspects of the invention relate generally to virtual pharmacies, and more particularly to systems and methods for variable customer pricing for virtual pharmacies.

### BACKGROUND OF THE INVENTION

In the United States, self-insured employers provide health insurance and wellness benefits to more than 30 million employees and cover more than 100 million total lives, including dependents and retirees. This makes up the largest single segment of healthcare, and self-insured employers as a group are the largest payors. As healthcare prices continue to rapidly rise, this is placing a huge financial strain on these employers.

The average employee healthcare costs have grown from around $5,000 in 2000 to more than $10,000 in 2010, and many experts believe that this growth will accelerate over the next decade with estimates ranging well above $30,000 per employee per year in 2020. With this predicted level of growth in healthcare costs, self-insured employers and other payors are struggling with how to manage the acceleration in healthcare costs.

Indeed, it will be appreciated that the problem of rising healthcare costs is not limited to simply self-insured employers. In particular, third-party payors such as insurance companies and pharmacy benefit managers (PBMs) face similar problems with controlling rising healthcare costs, which ultimately result in higher premiums and charges to employers, insured employees, and/or other insured patients.

Current statistics show that on average, prescription drug or product spend is around 20% of the annual costs of healthcare. Thus, there can be significant savings in managing the costs of prescription drugs or products. Accordingly, there is an opportunity for systems and methods for variable customer pricing for virtual pharmacies.

### SUMMARY OF THE INVENTION

Some or all of the above needs and/or problems may be addressed by certain embodiments of the invention. According to an embodiment of the invention, there is disclosed a method for determining patient pricing for one or more drugs or products. The method may include receiving, by a non-dispensing virtual pharmacy comprising one or more computers, an electronic prescription associated with a patient, where the electronic prescription is associated with at least one drug or product prescribed for the patient; determining, by the non-dispensing virtual pharmacy, a respective total price payable to each of the plurality of dispensing pharmacies for filling the prescription for the patient; determining, by the non-dispensing virtual pharmacy based upon the determined respective total price, a respective patient payable amount for filling the prescription at each of the plurality of dispensing pharmacies; and delivering, in real-time from the non-dispensing virtual pharmacy to a patient device, an identification of the plurality of dispensing pharmacies and the respective patient payment amount at each dispensing pharmacy.

According to another embodiment of the invention, a system is provided. The system may include at least one memory that stores computer-executable instructions, and at least one processor configured to access the at least one memory. At least one processor may be configured to execute the computer-executable instructions to: receive an electronic prescription associated with a patient, where the electronic prescription is associated with at least one drug or product prescribed for the patient; determine a respective total price payable to each of the plurality of dispensing pharmacies for filling the prescription for the patient; determine, based upon the determined respective total price, a respective patient payable amount for filling the prescription at each of the plurality of dispensing pharmacies; and deliver, in real-time to a patient device, an identification of the plurality of dispensing pharmacies and the respective patient payment amount at each dispensing pharmacy. At least one memory and at least one processor are associated with a non-dispensing virtual pharmacy.

### BRIEF DESCRIPTION OF THE DRAWINGS

Reference will now be made to the accompanying drawings, which are not necessarily drawn to scale, and wherein:

FIG. 1 illustrates an example virtual pharmacy system, according to an example embodiment of the invention.

FIG. 2 illustrates an example block diagram of an example implementation for a virtual pharmacy healthcare system, according to an example embodiment of the invention.

FIGS. 3 and 4 illustrates a respective block diagram and a respective flow diagram illustrating example operations and interactions of a virtual pharmacy, according to an example embodiment of the invention.

FIG. 5 illustrates an example process for generating an image of a paper prescription, according to an example embodiment of the invention.

FIG. 6 illustrates an example process for determining a pharmacy location preference of a patient, according to an example embodiment of the invention.

FIG. 7 illustrates an example cost optimization process for determining a cost of filling a prescription at one or more dispensing pharmacies for a patient, according to an example embodiment of the invention.

FIG. 8 illustrates an example process for determining respective patient payable amounts for filling a prescription at one or more dispensing pharmacies, according to an example embodiment of the invention.

FIG. 9 illustrates another example process for determining respective patient payable amounts for filling a prescription at one or more dispensing pharmacies, according to an example embodiment of the invention.

FIG. 10 illustrates another example process for determining respective patient payable amounts for filling a prescription at one or more dispensing pharmacies, according to an example embodiment of the invention.

FIG. 11 illustrates an example process for determining or identifying any applicable incentives for filling a prescription at one or more dispensing pharmacies, according to an example embodiment of the invention.

FIG. 12 illustrates a process for example financial processing, according to an example embodiment of the invention.

FIG. 13 illustrates an example user interface to facilitate capturing an image of a paper prescription, according to an example embodiment of the invention.

FIG. 14 illustrates an example user interface presenting information regarding one or more available dispensing pharmacies for selection by a patient, according to an example embodiment of the invention.

### DETAILED DESCRIPTION

Example embodiments of invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Example embodiments of the invention may be directed towards interactive virtual pharmacies interfacing between patients/healthcare providers and dispensing pharmacies, thereby facilitating management of prescription drug or product costs. In an example embodiment of the invention, an example virtual pharmacy may be virtual in that the virtual pharmacy may be a non-dispensing pharmacy that does not actually fill or dispense any drugs or products. Instead, an example virtual pharmacy may serve as an intermediary by which a patient or customer can receive information about a plurality of dispensing pharmacies as well as their cost or pricing structures for filling one or more prescriptions, as well as conduct one or more healthcare transactions with one or more of a plurality of dispensing pharmacies that can actually fill or dispense the drug or product to the patient.

An example virtual pharmacy in accordance with an example embodiment of the invention can operate seamlessly with existing healthcare provider infrastructure and systems. For example, if a healthcare provider (e.g., a prescribing physician) currently utilizes an industry standard healthcare transaction to deliver an electronic prescription to an actual (or non-virtual) or dispensing pharmacy, the healthcare provider can likewise use the same industry standard transaction to deliver an electronic prescription to a virtual pharmacy. In particular, like an actual/dispensing pharmacy, a virtual pharmacy may also be assigned a Destination ID. Accordingly, a particular Destination ID can be included in a corresponding field of the standard healthcare transaction to designate either a virtual pharmacy or an actual/dispensing pharmacy as a destination of the healthcare transaction. In an example embodiment of the invention, the standard healthcare transaction can be an electronic prescription in an e-prescribing Electronic Data Interchange (EDI) format. Likewise, in an example embodiment, a healthcare provider can alternatively deliver some prescriptions to actual/dispensing pharmacies via facsimile or via an Internet website. A virtual pharmacy in accordance with an example embodiment of the invention may likewise receive prescriptions via facsimile or via an Internet website. Accordingly, a healthcare provider can interact with a virtual pharmacy using existing infrastructure and systems currently used for interacting with actual/dispensing pharmacies.

Similarly, a patient or customer can likewise interact with a virtual pharmacy using a patient device/computer via an internet browser, mobile phone application, or other software. A patient device/computer can include a mobile smart phone (e.g., Apple iPhone, Android-based phone, Microsoft-based mobile phone) or a similar personal communications device (e.g., a tablet computer, etc.). In this regard, a patient device/computer can deliver or direct the delivery of an electronic prescription to a virtual pharmacy and, in response, receive cost/pricing and incentive information associated with filling the prescription at one or more actual/dispensing pharmacies. The cost/pricing information can include a total price or cost payable by the payor (e.g., self-insured employer, an insurance company, a pharmacy benefits manager (PBM), etc.) to each of the plurality of pharmacies for filling the prescribed drug or product for the patient, as well as a patient payable amount. In addition to pricing information, the virtual pharmacy can likewise deliver or direct the delivery to the patient device/computer, incentive or disincentive/penalty information associated with filling the prescription at one or more of the plurality of dispensing pharmacies. Accordingly, the patient or customer may be presented with a listing of various dispensing pharmacy locations and associated cost/pricing or incentive information in order facilitate a patient or customer's decision as to which pharmacy to fill a prescription at. The patient or customer can then use the patient device/computer to select a dispensing pharmacy to fill the prescription at, and the selection may be delivered to the non-dispensing virtual pharmacy. Based upon the patient or customer selection, a virtual pharmacy can direct a delivery of the prescription to the selected dispensing pharmacy. If the selected dispensing pharmacy is a retail pharmacy, then the patient or customer can the visit the actual/dispensing pharmacy location to receive the prescription drug or product corresponding to the filled prescription. On the other hand, if the selected dispensing pharmacy is a mail-order pharmacy, the prescription drug or product corresponding to the filled prescription can be mailed, couriered, or otherwise delivered to a location of the patient or customer. It will be appreciated that with an example virtual pharmacy, the patient or customer avoids the need to research pricing structures of various pharmacies in order to decide which pharmacy to fill the prescription at.

Example embodiments of the invention may likewise provide a virtual pharmacy that operates in real-time to communicate with healthcare providers, patients or customers, and/or actual/dispensing pharmacies. As an example, the virtual pharmacy can respond in real-time to the receipt of an electronic prescription from a healthcare provider (e.g., prescribing physician) or patient. For example, the virtual pharmacy can perform one or more real-time processes to determine actual/dispensing pharmacies that meet the location preferences and/or healthcare plan “in-network” requirements of the patient or customer, as well as determine cost/pricing (and/or incentive) information associated with filling the prescription at one or more of the dispensing pharmacy locations. The virtual pharmacy can then deliver or direct the delivery of the pricing (and/or incentive) information in real-time to the patient device/computer. Once the non-dispensing virtual pharmacy receives a selection of a dispensing pharmacy from the patient device, the virtual pharmacy can deliver or direct the delivery of the prescription to the selected dispensing pharmacy. By operating in real-time, an example non-dispensing virtual pharmacy can facilitate the patient or customer selection of a dispensing pharmacy as well as the delivery of the prescription to the selected dispensing pharmacy.

An example virtual pharmacy in accordance with an example embodiment of the invention may be implemented as part of a service provider computer, or another computer operating in tandem or in conjunction with the service provider computer. The service provider computer may be configured to route or deliver healthcare transactions (e.g., electronic prescriptions, prescription claim transactions, eligibility verification transactions, etc.) between or among healthcare provider computers, pharmacy computers, and patient devices/computers, as well as other computers such as payor computers. Accordingly, the service provider computer can leverage or invoke the operations of the virtual pharmacy described herein when a healthcare transaction is received that designates the non-dispensing virtual pharmacy instead of an actual/dispensing pharmacy.

Certain embodiments of the invention described herein may have the technical effect of a virtual pharmacy determining a dispensing pharmacy and cost/pricing information based upon a received prescription. The virtual pharmacy can then deliver pharmacy and pricing information to a patient device/computer and likewise receive a selection of a pharmacy from the patient device/computer. Based upon the selection, the virtual pharmacy can deliver a prescription to the selected dispensing pharmacy for filling. In this way, a patient may not need to perform independent research prior to selecting a dispensing pharmacy, and can make an optimal solution proactively. Indeed, the patient will be directed towards a dispensing pharmacy based upon the availability of cost/pricing information, as well as any available incentives, according to an example embodiment of the invention.

Example embodiments of the invention may refer to an individual as a “patient.” It will be appreciated that the patient can be the individual that is prescribed a drug or product by a healthcare provider. Likewise, the patient can be the individual that picks up a drug or product from a dispensing pharmacy. However, in some example embodiments, the patient can also include any person authorized by or acting on behalf of the patient. For example, a parent may be a person authorized to act on behalf a child who is the patient. Likewise, a caregiver or spouse may be a person authorized to act on behalf of a patient. Accordingly, while a “patient” device/computer may be referred to herein, that device/computer may belong to the patient or any other person (e.g., parent, spouse, caregiver, etc.) authorized by or acting on behalf of the patient. Similarly, either the patient or a person authorized to act on behalf of the patient may pick up or receive a drug or product for the patient from the pharmacy. Accordingly, a patient may refer to an actual patient or any person authorized to act on behalf of the patient.

General Overview

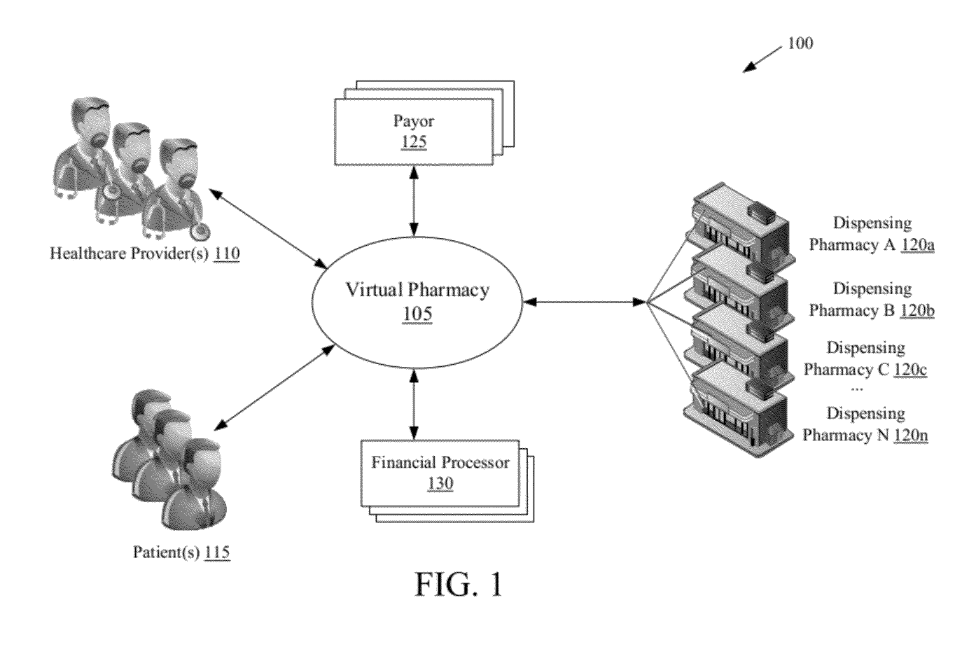

FIG. 1 illustrates an example virtual pharmacy system 100, according to an example embodiment of the invention. As shown in FIG. 1, there may be a virtual pharmacy 105. The virtual pharmacy 105 may be in communication with one or more healthcare providers 110, patients 115, and actual/dispensing pharmacies 120a-n. The one or more healthcare providers 110 can communicate with the virtual pharmacy 105 using respective healthcare provider computers, mobile devices, or facsimiles. Likewise, the one or more patients 115 can communicate with the virtual pharmacy 105 using respective computers or mobile devices, which may include smart phones or other personal communication devices, according to an example embodiment of the invention. The one or more actual/dispensing pharmacies 120a-n can communicate with the virtual pharmacy 105 using respective pharmacy computers, mobile devices, or facsimiles. Many other variations of electronic communications are available between or among the virtual pharmacy 105, the healthcare providers 110, and the pharmacies 120a-n.

In an example embodiment of the invention, a virtual pharmacy 105 may be virtual in that the virtual pharmacy 105 may not actually fill or dispense any drugs or products. Instead, an example non-dispensing virtual pharmacy may serve as an intermediary, coordinator, or facilitator that can provide one or more of the following functionalities:
receive a prescription from a healthcare provider 110 or patient 115, where the prescription can identify one or more drugs or products for the patient 115;
determine and deliver cost/pricing and incentive (or disincentive/penalty) information to the patient 115 about actual/dispensing pharmacies 120a-n that can fill the prescription and dispense the requested drug or product to the patient 115,
receive a selection from the patient 115 for one or more actual/dispensing pharmacies 120a-n to fill the prescription at;
deliver the prescription to one of the actual/dispensing pharmacies 120a-n; and/or
coordinate, with a financial processor 130, one or more financial transactions associated with the filling of the prescription.

To support one or more of the foregoing functionalities, the virtual pharmacy 105 may receive or otherwise obtain registration, configuration, and/or preference information associated with one or more healthcare providers 110, patients 115, or pharmacies 120a-n.

As an example, a patient 115 may register to access one or more services of the virtual pharmacy 105. The registration of the patient 115 may occur via an Internet portal, or otherwise, via telephone, facsimile, or other electronic communications means. As an example, a patient 115 may use a computer or mobile device to access an Internet registration web portal, which can including access via an Internet browser or a downloaded mobile client application. In some example embodiments of the invention, the Internet registration web portal can be provided or supported by a payor 125 (e.g., self-insured employer website, insurance website, PBM website, etc.) associated with the patient 115, or otherwise supported by another service provider, including one associated with the virtual pharmacy 105. For instance, if the payor 125 is a self-insured employer, then the Internet registration web portal may be part of the employer's HR/benefits administration portal, according to an example embodiment of the invention. The Internet registration web portal can also include one or more hyperlinks or universal resource location (URL) links that can direct the patient 115 to another web server, which may provide for registration and/or a mobile client application download. In some instances, the patient 115 may be the only covered individual by the payor 125, and the patient 115 can simply provide his or her own registration information via the Internet registration portal. However, in other embodiments, there may be other covered individuals (e.g., spouse, dependants, etc.) associated with the patient 115 who may likewise need to be registered. Accordingly, the registration information, or at least a portion thereof, for those other covered individuals may likewise be captured during an example registration process. For example, a patient 115 may have the ability to completely register those other covered individuals. Alternatively, the patient 115 may simply provide a communications address (e.g., telephone number, email address, mailing address, etc.) for informing the covered individuals regarding registration for one or more services of the virtual pharmacy 105. For example, a URL link for accessing a registration website or downloading a mobile client application can be delivered via short messaging service (SMS) or multimedia messaging service (MMS) to a mobile telephone number and/or email address.

It will be appreciated that as part of the registration of a patient 115, one or more of the following information can be captured:
Patient Contact Information, which may include any of the following:
   Patient Name
   Patient Address
   Patient Phone Number(s) (e.g., work phone number, home phone number, mobile phone number)
   Patient Fax Number
   Patient Email
Patient Cardholder Information, which may include any of the following:
   Patient Cardholder ID assigned by payor 125
   Group ID
Patient Contact Preferences: Specifies the type of communication preferred with the virtual pharmacy 105. For real-time communications, this may include SMS or MMS delivery to a patient mobile phone number, or Internet-based communications with a mobile client application of a patient mobile phone. For non-real-time communications, this may include communications via facsimile or email, according to an example embodiment of the invention.
Pharmacy Location Preferences, which may include any of the following:
   Specific Preferred Pharmacy(ies): Specifically identities one or more particular pharmacies that are preferred by the patient 115. If multiple pharmacies are identified, there may be a prioritization order for determining the pharmacies.
   Specified Location and Distance/Radius: Specifies an address, or any portion thereof (e.g., a zip code), for purposes of locating pharmacies within proximity to the specified address or portion thereof. To determine the proximity, a radius can also be specified to indicate a distance from the specified address or portion thereof. The specified address or portion thereof can be either a patient 115 address or an address of a healthcare provider. If the address of the healthcare provider is to be used, it can alternatively be obtained from an electronic prescription at the time the electronic prescription is received by the virtual pharmacy 105.
   Current Address and Distance/Radius: The virtual pharmacy can determine a current address of the patient at the time an electronic prescription is received. This current address may be based upon global positioning system (GPS) coordinates associated with a patient mobile device. Alternatively, the current address may be specified by or requested from the patient at the time an electronic prescription is received by the virtual pharmacy 105.

In an example embodiment of the invention, a patient 115 does not need to have an association with any payor 125 in order to access one or more services of virtual pharmacy, as described herein. For example, one or more services of the virtual pharmacy can also be available for cash customers, according to an example embodiment of the invention. In particular, a cash customer may be a customer that does not utilize any insurance, coverage, or other third-party payor when filling a prescription at a dispensing pharmacy 120a-n. The registration of a cash customer can be available via any of the communications means described herein, including an Internet website/portal, telephone, or facsimile, according to an example embodiment of the invention.

It will be appreciated that healthcare providers 110 and dispensing pharmacies 120a-n can similarly register to access one or more services of the virtual pharmacy 105. In this regard, the registration may occur via an Internet portal, or otherwise via telephone, facsimile, or other electronic communications means, as similarly described above. The healthcare providers 110 and dispensing pharmacies 120a-n may include identification information, which may include a national provider identifier (NPI) or other identifier, as well as contact information and preferences. For example, the healthcare providers 110 and/or dispensing pharmacies 120a-n may indicate how they wish to communicate with the virtual pharmacy. For example, a pharmacy 120a-n may specify a fax number for receiving a prescription from the virtual pharmacy. It will be appreciated that additional information and identifiers can be received from the healthcare providers 110 and/or pharmacies 120a-n in accordance with example embodiments of the invention.

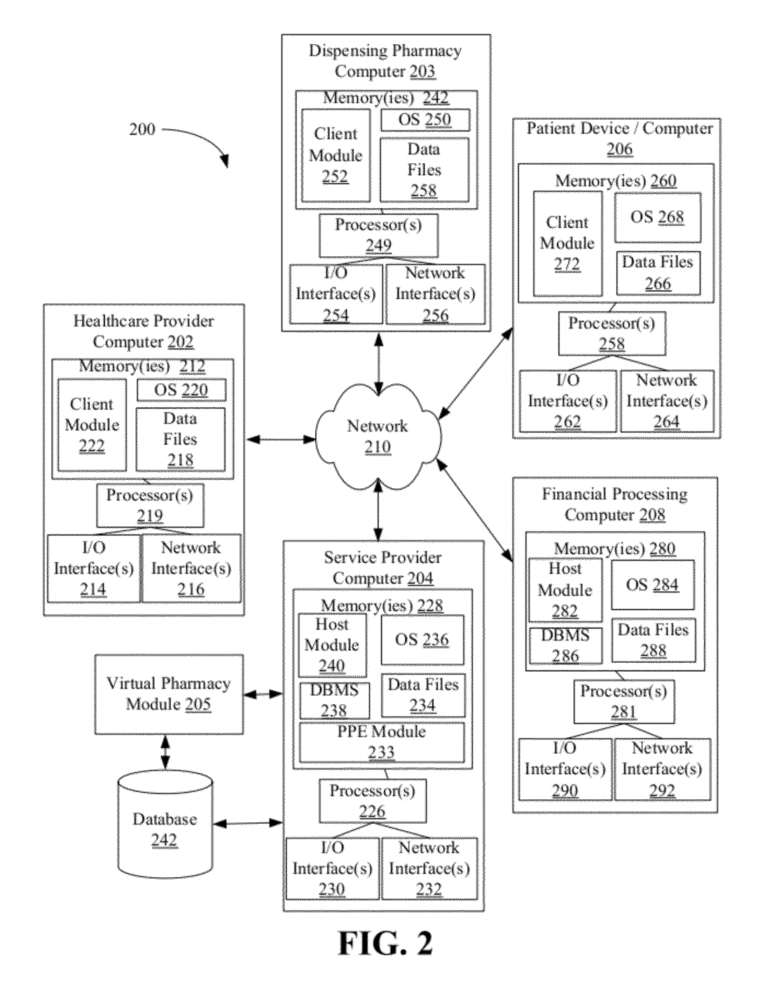

FIG. 2 illustrates an example block diagram of an example implementation for a virtual pharmacy healthcare system 200, according to an example embodiment of the invention. As shown in FIG. 2, the healthcare system 200 may include at least one healthcare provider computer 202, at least one dispensing pharmacy computer 203, at least one service provider computer 204, at least one patient device/computer 206, and at least one financial processing computer 208. As desired, each of the healthcare provider computers 202, dispensing pharmacy computers 203, service provider computers 204, patient devices/computers 206, and financial processing computers 208 may include one or more processing devices that may be configured for accessing and reading associated computer-readable media having stored thereon data and/or computer-executable instructions for implementing the various methods of the invention.

Generally, network devices and systems, including one or more of the healthcare provider computers 202, pharmacy computers 203, service provider computers 204, patient devices/computers 206, and financial processing computers 208, may include or otherwise be associated with suitable hardware and/or software for transmitting and receiving data and/or computer-executable instructions over one or more communications links or networks. These network devices and systems may also include any number of processors for processing data and executing computer-executable instructions, as well as other internal and peripheral components that are well known in the art. Further, these network devices and systems may include or be in communication with any number of suitable memory devices operable to store data and/or computer-executable instructions. By executing computer-executable instructions, each of the network devices may form a special purpose computer or particular machine. As used herein, the term “computer-readable medium” describes any form of suitable memory or memory device.

As shown in FIG. 2, the healthcare provider computer 202, pharmacy computer 203, service provider computer 204, patient device/computer 206, and financial processing computer 208 may be in communication with each other via one or more networks, such as network 210, which as described below can include one or more separate or shared private and public networks, including the Internet or a publicly switched telephone network. Each of these components—the healthcare provider computer 202, the pharmacy computer 203, the service provider computer 204, the patient device/computer 206, the financial processing computer 208, and the network 210—will now be discussed in further detail.

First, the healthcare provider computer 202 may be associated with a healthcare provider 110 such as a physician, physician group, hospital, or other prescriber of a drug or product. The healthcare provider computer 202 may be any suitable processor-driven device that facilitates the generation and delivery of healthcare transaction requests or electronic prescriptions to a service provider computer 204 or to a pharmacy computer 203, either directly or through the service provider computer 204. The healthcare provider computer 202 may include a server computer, a mainframe computer, one or more networked computers, a desktop computer, a personal computer, a digital assistant, a personal digital assistant, a digital tablet, an Internet appliance, an application-specific circuit, a microcontroller, a minicomputer, or any other processor-based device. The execution of the computer-implemented instructions by the healthcare provider computer 202 may form a special purpose computer or other particular machine that is operable to facilitate the generation of healthcare transaction requests or electronic prescriptions for patients and the communication of information associated with the healthcare transaction requests or electronic prescriptions to a service provider computer 204 or a pharmacy computer 203. Additionally, in certain embodiments of the invention, the operations and/or control of the healthcare provider computer 202 may be distributed amongst several processing components.

In addition to having one or more processors 219, the healthcare provider computer 202 may include one or more memory devices 212, one or more input/output (I/O) interface(s) 214 and one or more network interface(s) 216. The memory devices 212 may be any suitable memory devices, for example, caches, read-only memory devices, random access memory devices, magnetic storage devices, removable storage devices, etc. The memory devices 212 may store data, executable instructions, and/or various program modules utilized by the healthcare provider computer 202, for example, data files 218, an operating system (OS) 220, and/or a client module 222.

The data files 218 may include any suitable data that facilitates the generation and/or delivery of healthcare transaction requests or electronic prescriptions by the healthcare provider computer 202. The OS 220 may be a suitable software module that controls the general operation of the healthcare provider computer 202. The OS 220 may also facilitate the execution of other software modules by the one or more processors 219, for example, the client module 222. The OS 220 may be, but is not limited to, Microsoft Windows®, Apple OSX™, Linux, Unix, or a mainframe operating system.

The client module 222 may include an interface, such as a dedicated software program and/or an Internet browser, for interacting with the service provider computer 204, the pharmacy computer 203, or another component of the healthcare system 200. For example, a user such as a physician or prescriber may utilize the client module 222 in preparing and delivering a healthcare transaction request or an electronic prescription to the appropriate service provider computer 204 and/or pharmacy computer 203. The healthcare provider computer 202 may also utilize the client module 222 to retrieve or otherwise receive data, messages, or responses from the service provider computer 204, the pharmacy computer 203, and/or other components of the healthcare system 200.

The one or more I/O interfaces 214 may facilitate communication between the healthcare provider computer 202 and one or more input/output devices, for example, an optical scanner, bar code scanner, RFID reader, and the like. For example, the one or more I/O interfaces 214 may facilitate entry of information associated with a healthcare transaction request or electronic prescription by a physician or other prescriber. The one or more network interfaces 216 may facilitate connection of the healthcare provider computer 202 to one or more suitable networks, for example, the network 210 illustrated in FIG. 2 or any other healthcare transaction network. In this regard, the healthcare provider computer 202 may receive and/or communicate information to other network components of the system 200, such as the service provider computer 204 and/or the pharmacy computer 203.

Second, the pharmacy computer 203 may be associated with a pharmacy, a pharmacy group, or other product dispensing entity such as any one of the pharmacies 120a-n. The pharmacy computer 203 may be any suitable processor-driven device that facilitates the receipt and processing of healthcare transaction requests or electronic prescriptions from a healthcare provider computer 202 and/or a service provider computer 204. The pharmacy computer 203 can also facilitate the generation or processing of any billing or reimbursement claim transactions that are associated with electronic prescriptions, including the generation and delivery of reimbursement healthcare claims to a financial processing computer 208 for adjudication. The pharmacy computer 203 may include a server computer, a mainframe computer, one or more networked computers, a desktop computer, a personal computer, a digital assistant, a personal digital assistant, a digital tablet, an Internet appliance, an application-specific circuit, a microcontroller, a minicomputer, or any other processor-based device. The execution of the computer-implemented instructions by the pharmacy computer 203 may form a special purpose computer or other particular machine that is operable to facilitate processing of healthcare transaction requests or electronic prescriptions, as well as the generation or processing of any billing or reimbursement claim transactions associated with electronic prescriptions. Additionally, in certain embodiments of the invention, the operations and/or control of the pharmacy computer 203 may be distributed amongst several processing components.

In addition to having one or more processors 249, the pharmacy computer 203 may include one or more memory devices 242, one or more input/output (I/O) interface(s) 254, and one or more network interface(s) 256. The memory devices 242 may be any suitable memory devices, for example, caches, read-only memory devices, random access memory devices, magnetic storage devices, removable storage devices, etc. The memory devices 242 may store data, executable instructions, and/or various program modules utilized by the pharmacy computer 203, for example, data files 258, an operating system (OS) 250, and/or a client module 252.

The data files 258 may include any suitable data that facilitates the receipt and/or processing of healthcare transaction requests or prescription orders and the generation and/or processing of any billing or reimbursement claim transactions associated with electronic prescriptions. For example, the data files 258 may include, but are not limited to, product inventory information, healthcare information and/or contact information associated with one or more patients, information associated with one or more healthcare provider computers 202, information associated with the service provider computer 204, and/or information associated with one or more electronic prescriptions, healthcare claim transactions, or financial transactions. The operating system (OS) 250 may be a suitable software module that controls the general operation of the pharmacy computer 203. The OS 250 may also facilitate the execution of other software modules by the one or more processors 249, for example, the client module 252. The OS 250 may be, but is not limited to, Microsoft Windows®, Apple OSX™, Linux, Unix, or a mainframe operating system.

The client module 252 may include an interface, such as a dedicated software program and/or an Internet browser, for interacting with the healthcare provider computer 202, the service provider computer 204, the patient device/computer 206, the financial processing computer 208, or any other component of the healthcare system 200. For example, a user such as a pharmacist or other pharmacy employee may utilize the client module 252 to receive or retrieve an electronic prescription that was delivered from a healthcare provider computer 202 and/or the service provider computer 204. Likewise, the pharmacist or other pharmacy employee may utilize the client module 252 in preparing and providing a prescription claim request for delivery to an appropriate financial processing computer 208. The pharmacy computer 203 may also utilize the client module 252 to retrieve or otherwise receive data or responses from the healthcare provider computer 202 and/or the service provider computer 204.

The I/O interface(s) 254 may facilitate communication between the processor 249 and various I/O devices, such as a keyboard, mouse, printer, microphone, speaker, monitor, bar code readers/scanners, RFID readers, and the like. The network interface(s) 256 may take any of a number of forms, such as a network interface card, a modem, a wireless network card, and the like.

Third, the service provider computer 204 may include any number of special purpose computers or other particular machines, application-specific circuits, microcontrollers, personal computers, minicomputers, mainframe computers, servers, networked computers, and/or other processor-driven devices. In certain embodiments, the operations of the service provider computer 204 may be controlled by computer-executed or computer-implemented instructions that are executed by one or more processors associated with the service provider computer 204 to form a special purpose computer or other particular machine that is operable to coordinate, facilitate, or direct the receipt, routing, and/or processing of healthcare transactions, including electronic prescriptions, billing or reimbursement claim transactions, financial transactions, or other healthcare transactions. The one or more processors that control the operations of the service provider computer 204 may be incorporated into the service provider computer 204 and/or may be in communication with the service provider computer 204 via one or more suitable networks or other communications means. In certain embodiments of the invention, the operations and/or control of the service provider computer 204 may be distributed amongst several processing components.

The service provider computer 204 may include one or more processors 226, one or more memory devices 228, one or more input/output (“I/O”) interface(s) 230, and one or more network interface(s) 232. The one or more memory devices 228 may be any suitable memory devices, for example, caches, read-only memory devices, random access memory devices, magnetic storage devices, removable memory devices, etc. The one or more memory devices 228 may store data, executable instructions, and/or various program modules utilized by the service provider computer 204, for example, data files 234, an operating system (OS) 236, the host module 240, a pre- and -post editing (PPE) module 233, and a database management system (“DBMS”) 238 to facilitate management of data files 234 and other data stored in the memory devices 228 and/or one or more databases 242. The OS 236 may be, but is not limited to, Microsoft Windows®, Apple OSX™, Linux, Unix, or a mainframe operating system.

According to an embodiment of the invention, the data files 234 may store healthcare transaction records associated with communications received from various healthcare provider computers 202, pharmacy computers 203, patient devices/computers 206, financial processing computers 208, or any other components of the healthcare system 200. The data files 234 may also store any number of suitable routing tables that facilitate determining the destination of communications received from a healthcare provider computer 202, pharmacy computer 203, patient device/computer 206, and/or financial processing computer 208. The host module 240 may receive, process, and respond to requests from the client module 222 of the healthcare provider computer 202, the client module 252 of the pharmacy computer 203, the client module 272 of the patient device/computer 206, and the host module 282 of the financial processing computer 208. For example, the host module 240 may receive and process electronic prescriptions or other healthcare transaction requests from the healthcare provider computer 202, pharmacy computer 203, and/or the patient device/computer 206. The host module 240 may also be operative to generate and deliver financial transaction requests to a financial processing computer 208.

The PPE module 233 may be operable to perform one or more pre-edits on a received healthcare transaction request (e.g., electronic prescriptions, billing claim requests, etc.) prior to routing or otherwise communicating the received healthcare transaction request to a suitable destination such as a pharmacy computer 203 or financial processing computer 208. Additionally, the PPE module 233 may be operable to perform one or more post-edits on a reply or response that is received from a financial processing computer 208 or pharmacy computer 203 prior to routing a corresponding reply or response to the originating computer such as the healthcare provider computer 202 or the patient device/computer 206. A wide variety of different pre-edits and/or post-edits may be performed as desired in various embodiments of the invention.

The service provider computer 204 may include additional program modules for performing other processing methods described herein. Those of ordinary skill in the art will appreciate that the service provider computer 204 may include alternate and/or additional components, hardware or software without departing from example embodiments of the invention.

The service provider computer 204 may communicate with, or otherwise include, a virtual pharmacy module 205 for providing services in accordance with a virtual pharmacy. The virtual pharmacy module 205 may include computer-executable instructions that are executable by the service provider computer 204 or another computer that operates in tandem or in conjunction with the service provider computer 204. The execution of the computer-executable instructions can provide one or more virtual pharmacies (e.g., a virtual pharmacy 105), where each virtual pharmacy may support or provide one or more of the following example virtual pharmacy services:
receive a prescription from a healthcare provider computer 202 or patient device/computer 206, where the prescription can identify or request one or more drugs or products, including an associated quantity, for a patient 115;
determine and deliver pricing and incentive (or penalty) information to the patient device/computer 206 about actual/dispensing pharmacies that can fill the prescription (e.g., providing the requested drug or product to the patient 115);
receive a selection from the patient 115 (e.g., via the patient device/computer 206) for one or more actual/dispensing pharmacies to fill the prescription at;
deliver the prescription to a pharmacy computer 203 associated with one of the actual/dispensing pharmacies; and/or
coordinate, with a financial processing computer 208, one or more financial transactions associated with the filling of the prescription.

In providing one or more of the above-identified example services, the virtual pharmacy module 205 may access, or otherwise receive information from, the database 242 and/or the data files 234. The database 242 and/or memory 228 may store, for example, transaction records, patient information (e.g., identification information, preferences, etc.), eligibility information, incentive/penalty information and/or other healthcare information. It will be appreciated that the virtual pharmacy module 205 may be implemented as a single module for multiple virtual pharmacies, or as respective modules for each virtual pharmacy. In an example embodiment of the invention, each virtual pharmacy may be associated with a payor (e.g., self-insured employer, insurance company, PBM, etc.) and patients covered by or otherwise associated therewith. In other example embodiments of the invention, a virtual pharmacy may be associated with multiple payors and their respective covered patients. In yet another embodiment, a virtual pharmacy can also be associated with cash customers. In another embodiment, there may only be a single virtual pharmacy handling all patients and customers, irrespective of coverage or insurance status.

It will be appreciated that in example embodiments, the virtual pharmacy module 205 and/or the database 242 may be provided in part or entirely within the service provider computer 204. In yet other embodiments, the virtual pharmacy module 205 and/or the database 242 may be provided in part or entirely within one or more of the other entities' systems, such as at the healthcare provider computer 202, the pharmacy computer 203, the patient device/computer 206, and/or at the financial processing computer 208. If the service provider computer 204 includes the virtual pharmacy module 205 and/or the database 242, then the database 242 could also be part of the memory 228, and the virtual pharmacy module 205 can be stored in the memory 228.

Although a single database 242 is referred to herein for simplicity, those of ordinary skill in the art will appreciate that multiple physical and/or logical data storage devices or databases may be used to store the above mentioned data. For security and performance purposes, the service provider computer 204 may have a dedicated connection to the database 242. However, the service provider computer 204 may also communicate with the database 242 via the network 210 as shown, or via another network.

The patient device/computer 206 may be associated with a patient such as patient 115. The patient device/computer may be any suitable processor-driven device that facilitates the generation and delivery of healthcare transaction requests/responses or electronic prescriptions to a service provider computer 204 or another component of the healthcare system 200. The patient device/computer 206 may include a desktop computer, a personal computer, a digital assistant, a personal digital assistant, a digital tablet, an Internet appliance, an application-specific circuit, a microcontroller, a minicomputer, a handheld or mobile device, or any other processor-based device. In an example embodiment of the invention, the patient device/computer 206 can be a handheld or mobile device such as an iPhone, a BlackBerry, or any other smart phone. The execution of computer-implemented instructions by the patient device/computer 206 may form a special purpose computer or other particular machine that is operable to facilitate the generation and delivery of healthcare transaction requests/responses or electronic prescriptions.

In addition to having one or more processors 258, the patient device/computer 206 may include one or more memory devices 260, one or more input/output (I/O) interface(s) 262, and one or more network interface(s) 264. The memory devices 260 may be any suitable memory devices, for example, caches, read-only memory devices, random access memory devices, magnetic storage devices, removable storage devices, etc. The memory devices 260 may store data, executable instructions, and/or various program modules utilized by the patient device/computer 206, for example, data files 266, an operating system (OS) 268, and/or a client module 272.

The data files 266 may include any suitable data that facilitates the generation and delivery of healthcare transaction requests/responses or electronic prescriptions. For example, the data files 266 can store patient information (e.g., cardholder ID, group ID), patient preferences such as pharmacy location preferences, patient financial information (e.g., account numbers, etc.), and the like. The operating system (OS) 268 may be a suitable software module that controls the general operation of the patient device/computer 206. The OS 268 may also facilitate the execution of other software modules by the one or more processors 258, for example, the client module 272. For example, where the patient device/computer 206 is a smart phone or other mobile device, the OS 268 may include Apple iOS, Symbian OS, Android OS, RIM BlackBerry OS, Windows Mobile, or a similar mobile OS. The OS 268 may be, but is not limited to, Microsoft Windows®, Apple OSX™, Linux, Unix, or another operating system.

The client module 272 may include an interface, such as a dedicated software program and/or an Internet browser, for interacting with the service provider computer 204 (and/or virtual pharmacy module 205) or another computer such as the pharmacy computer 203, the healthcare provider computer 202, and/or the financial processing computer 208. In an example embodiment of the invention, the client module can be a mobile application that is downloaded from an Internet website or network data store and installed on the patient device/computer 206. A patient such as patient 115 may utilize the client module 272 to perform at least one or more of the following functionalities for purposes of interacting with a virtual pharmacy:
Capture an image or picture of a paper prescription and deliver the captured image to the service provider computer 204 (and/or virtual pharmacy module 205);
Receive, from the service provider computer 204 (and/or virtual pharmacy module 205), pricing and incentive (or penalty) information for actual/dispensing pharmacies that can fill the prescription;
Provide a presentation to the patient of the one or more actual/dispensing pharmacies to fill the prescription along with accompanying pricing and incentive (or penalty) information as well as any location information, advertisement information, supporting healthcare information, and the like;
Enable the patient to select one or more of the actual/dispensing pharmacies to fill the prescription;
Deliver the patient selection of one or more actual/dispensing pharmacies to the service provider computer 204 (and/or virtual pharmacy module 205); and/or
Receive patient financial information from the patient 115, and deliver the patient financial information to the service provider computer 204 (and/or virtual pharmacy module 205).

The I/O interface(s) 262 may facilitate communication between the processor 258 and various I/O devices, such as a keyboard, touch screen, mouse, printer, microphone, speaker, monitor, bar code readers/scanners, RFID readers, and the like. The network interface(s) 264 may take any of a number of forms, such as a network interface card, a modem, a wireless network card, and the like.

The financial processing computer 208 may be a healthcare claims processor computer for a payor 125 or another processing computer associated with a financial processor 130. As an example, there may be a first financial processing computer 208 that operates as a healthcare claims processor computer for adjudicating healthcare claims to determine benefits and/or coverage, including determining covered amounts payable by a payor to a healthcare provider or pharmacy, as well as patient payable amounts (e.g., co-pay amount or co-insurance amounts). In this embodiment, the healthcare claims processor computer can be associated with a payor 125 such as an insurance company, a pharmacy benefits manager (PBM), a government payor, and the like.

Additionally or alternatively, there may be a second financial processing computer 208 associated with a financial processor 130 for conducting financial transactions with payment accounts, which can include deposit accounts (e.g., checking accounts, saving accounts, etc.), credit/debit card accounts, flexible spending accounts (FSAs)/healthcare savings accounts (HSAs), or other monetary transaction accounts (e.g., PayPal, mobile payments, etc.). In this regard, the second financial processing computer 208 can be associated with a financial transaction network such as a credit card processing network (e.g., VISA, MasterCard, American Express, etc.), an ATM/debit card processing network (e.g., PLUS, Interlink, etc.), an automated clearing house (ACH) network, a deposit account processing network, or a similar financial transaction network for flexible spending/healthcare savings accounts or other monetary transaction accounts.

As desired, the financial processing computer 208 may include any number of special purpose computers or other particular machines, application-specific circuits, microcontrollers, personal computers, minicomputers, mainframe computers, servers, and the like. In certain embodiments, the operations of the financial processing computer 208 may be controlled by computer-executed or computer-implemented instructions that are executed by one or more processors associated with the financial processing computer 208 to form a special purpose computer or other particular machine that is operable to facilitate the receipt, processing, and/or fulfillment of healthcare claim requests or financial transaction requests received from the service provider computer 204 or another computer such as the pharmacy computer 203. The one or more processors that control the operations of the financial processing computer 208 may be incorporated into the financial processing computer 208 and/or may be in communication with the financial processing computer 208 via one or more suitable networks. In certain embodiments of the invention, the operations and/or control of the financial processing computer 208 may be distributed amongst several processing components.

The financial processing computer 208 may include one or more processors 281, one or more memory devices 280, one or more input/output (I/O) interface(s) 290, and one or more network interface(s) 292. The one or more memory devices 280 may be any suitable memory device, for example, caches, read-only memory devices, random access memory devices, magnetic storage devices, removable memory devices, etc. The one or more memory devices 280 may store data, executable instructions, and/or various program modules utilized by the financial processing computer 208, for example, data files 288, an operating system (OS) 284, a database management system (DBMS) 286, and a host module 282. The data files 288 may include any suitable information that is utilized by the financial processing computer 208 to process healthcare claim transactions or financial transactions, for example, patient profiles, patient insurance information, other information associated with a patient, information associated with a healthcare provider, financial account information, etc. The operating system (OS) 284 may be a suitable software module that controls the general operation of the financial processing computer 208. The OS 284 may also facilitate the execution of other software modules by the one or more processors 281, for example, the DBMS 286 and/or the host module 282. The OS 284 may be, but is not limited to, Microsoft Windows®, Apple OSX™, Linux, Unix, or a mainframe operating system. The DBMS 286 may be a suitable software module that facilitates access and management of one or more databases that are utilized to store information that is utilized by the financial processing computer 208 in various embodiments of the invention. The host module 282 may initiate, receive, process, and/or respond to requests, such as healthcare claim requests or financial transaction requests, from the host module 240 of the service provider computer 204 or the client module 252 of the pharmacy computer 203. The financial processing computer 208 may include additional program modules for performing other pre-processing or post-processing methods described herein. Those of ordinary skill in the art will appreciate that the financial processing computer 208 may include alternate and/or additional components, hardware or software without departing from example embodiments of the invention.

The one or more I/O interfaces 290 may facilitate communication between the financial processing computer 208 and one or more input/output devices, for example, one or more user interface devices, such as a display, keypad, control panel, touch screen display, remote control, microphone, etc., that facilitate user interaction with the financial processing computer 208. The one or more network interfaces 292 may facilitate connection of the financial processing computer 208 to one or more suitable networks, for example, the network 210 illustrated in FIG. 2. In this regard, the financial processing computer 208 may receive healthcare claim requests, financial transaction requests, and/or other communications from the service provider computer 204 or pharmacy computer 203, and the financial processing computer 208 may communicate information (e.g., adjudication replies or approval/denial responses) associated with processing claim transactions or financial transactions to the service provider computer 204 or pharmacy computer 203.

The network 210 may include any telecommunication and/or data network, whether public, private, or a combination thereof, including a local area network, a wide area network, an intranet, the Internet, intermediate hand-held data transfer devices, and/or any combination thereof and may be wired and/or wireless. The network 210 may also allow for real-time, off-line, and/or batch transactions to be transmitted between or among the healthcare provider computer 202, the pharmacy computer 203, the service provider computer 204, the patient device/computer 206, and the financial processing computer 208. Due to network connectivity, various methodologies as described herein may be practiced in the context of distributed computing environments. Although the service provider computer 204 is shown for simplicity as being in communication with the healthcare provider computer 202, the pharmacy computer 203, the patient device/computer 206, or the financial processing computer 208 via one intervening network 210, it is to be understood that any other network configuration is possible. For example, intervening network 210 may include a plurality of networks, each with devices such as gateways and routers for providing connectivity between or among networks 210. Instead of or in addition to a network 210, dedicated communication links may be used to connect the various devices in accordance with an example embodiment of the invention. For example, the service provider computer 204 may form the basis of network 210 that interconnects two or more of the healthcare provider computer 202, the pharmacy computer 203, patient device/computer 206, and/or the financial processing computer 208.

The system 200 shown in and described with respect to FIG. 2 is provided by way of example only. Numerous other operating environments, system architectures, and/or device configurations are possible in various embodiments of the invention. Other system embodiments can include fewer or greater numbers of components and may incorporate some or all of the functionality described with respect to the system components shown in FIG. 2. For instance, in one example embodiment, the service provider computer 204 (or the healthcare provider computer 202, pharmacy computer 203, patient device/computer 206, or financial processing computer 208) may be implemented as a specialized processing machine that includes hardware and/or software for performing the methods described herein. In addition, the processor and/or processing capabilities of the service provider computer 204 and/or the virtual pharmacy module 205 may be implemented as part of the healthcare provider computer 202, the pharmacy computer 203, the patient device/computer 206, the financial processing computer 208, or any combination or portion thereof. Accordingly, embodiments of the invention should not be construed as being limited to any particular operating environment, system architecture, or device configuration.

Operational Overview

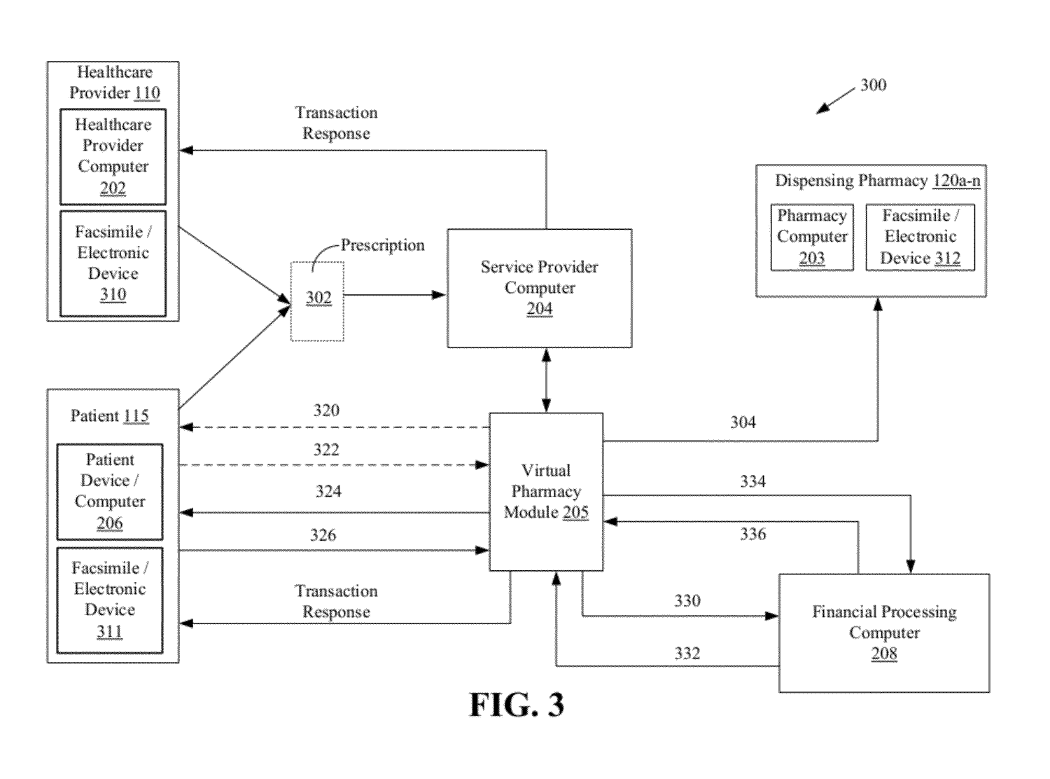

FIG. 3 illustrates a block diagram 300 illustrating example operations and interactions of a virtual pharmacy, according to an example embodiment of the invention.

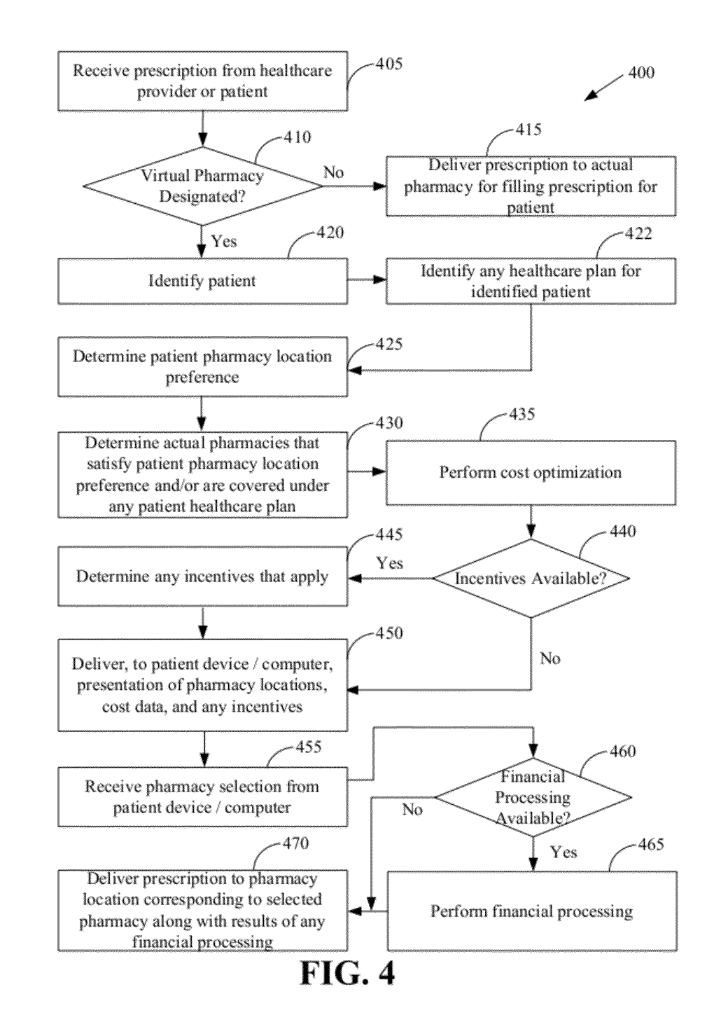

FIG. 4 illustrates an example flow diagram for a process 400 illustrating example operations and interactions of a virtual pharmacy, according to an example embodiment of the invention. One or more blocks of the example process 400 may be performed by a service provider computer 204 and/or virtual pharmacy module 205, according to an example embodiment of the invention.

At block 405, the service provider computer 204 and/or virtual pharmacy module 205 may receive an electronic prescription 302 from either a healthcare provider 110 or a patient 115. In an example embodiment of the invention, the electronic prescription 302 may be generated and delivered by a healthcare provider computer 202 as a healthcare transaction request in an e-prescribing script format such as a National Council for Prescription Drug Programs (NCPDP) SCRIPT form, an Electronic Data Interchange (EDI) ANSI format, an HL7 format, or the like. In this case, the electronic prescription 302 may be treated for legal purposes as an actual prescription without any paper prescription counterpart. The electronic prescription may include one or more of the following prescription information:

Product information
Drug or product identifier (e.g., National Drug Code (NDC)
Dispense Quantity of the drug or product
Number of Refills remaining
Form of drug or product (e.g., tablet, gel, etc.)
Dosage Instructions
Date of prescription

Patient Information
Patient Name
Patient Identifier
Patient Date of Birth (DOB)
Patient Contact Information (e.g., address, telephone number, etc.)

Provider Information
Prescriber/Healthcare provider ID (e.g., a National Provider Identifier (NPI) code or Drug Enforcement Administration (DEA) number)
Prescriber/Healthcare Provider ID Name
Prescriber/Healthcare Provider Contact Information

Insurance/Coverage Information
Cardholder Name (e.g., Cardholder First Name, Cardholder Last Name)
Cardholder ID and/or other identifier (e.g., person code)
Group ID and/or Group Information

Destination Identifier
Identification of a destination pharmacy (e.g., National Provider Identifier (NPI) code), which can include either an identifier of an actual/dispensing pharmacy or a virtual pharmacy.

In some example embodiments of the invention, the electronic prescription 302 may be a copy of a paper prescription, according to an example embodiment of the invention. For example, the healthcare provider 110 can use a facsimile or other electronic device 310 (e.g., a computer) to deliver a copy of a paper prescription to the service provider computer 204 and/or virtual pharmacy module 205. Likewise, the patient 115 can also use a facsimile or other electronic device 311 (e.g., a computer) to deliver a copy of a paper prescription to the service provider computer 204 and/or virtual pharmacy module 205. The service provider computer 204 and/or virtual pharmacy module 205 can include software and communications hardware for receiving a copy of the paper prescription in electronic form as electronic prescription 302 from the facsimile or other electronic device 310, 311. On the other hand, the service provider can have an employee or other agent retrieve an output from the facsimile or other electronic device 310, 311, and then enter the information for the electronic prescription 302 for receipt by the service provider computer 204 and/or virtual pharmacy module 205. Accordingly, the service provider computer 204 and/or virtual pharmacy module 205 can receive an electronic prescription 302 from the healthcare provider 110 or the patient 115. In an example embodiment of the invention, a copy of a paper prescription can include at least one or more of the following information typically found on a paper prescription:

Product information
Drug or product identifier (e.g., National Drug Code (NDC)
Dispense Quantity of the drug or product
Number of Refills remaining
Form of drug or product (e.g., tablet, gel, etc.)
Dosage Instructions
Date of prescription

Patient Information
Patient Name
Patient Identifier
Patient Date of Birth (DOB)

Provider Information
Prescriber/Healthcare provider ID (e.g., a National Provider Identifier (NPI) code or Drug Enforcement Administration (DEA) number)
Prescriber/Healthcare Provider ID Name
Prescriber/Healthcare Provider Contact Information
   It will be appreciated that yet additional information can be included with the electronic prescription 302 without departing from example embodiments of the invention.

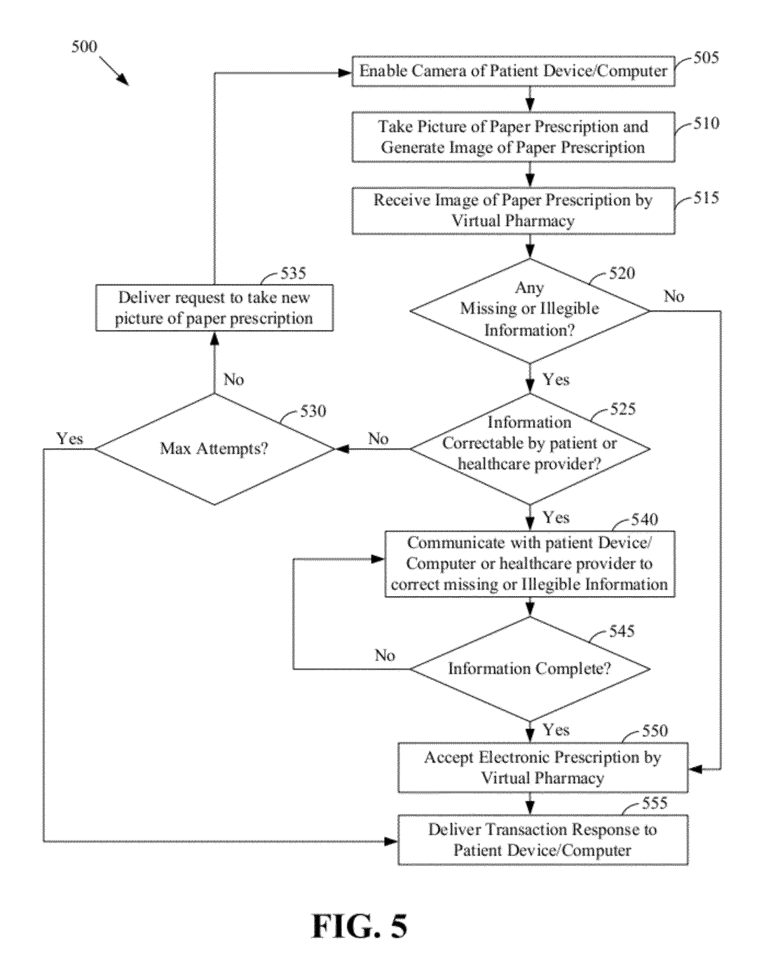

In yet another example embodiment of the invention, a patient 115 can also use software on a patient device/computer 206 to take a picture or image of a paper prescription, and deliver an electronic image of the paper prescription for receipt as electronic prescription 302 by the service provider computer 204 and/or virtual pharmacy module 205. An example process by which a patient 115 can use a patient device/computer 206 to take a picture of a paper prescription will be discussed herein with respect to FIG. 5. It will be appreciated that the image of the paper prescription can include similar information as that described with respect to the paper prescription. As such, the image of the paper prescription can include product information, provider information, and the like. In addition to the image of the paper prescription, the electronic prescription 302 may include identification of a destination pharmacy (e.g., National Provider Identifier (NPI) code), which can include either an identifier of an actual/dispensing pharmacy or a virtual pharmacy. However, this identification of the destination can be provided in a message, packet, frame, or other transmission separate from the electronic prescription 302 as well.

Following block 405 is block 410, where the service provider computer 204 and/or virtual pharmacy module 205 can determine whether the electronic prescription 302 is destined for a virtual pharmacy. To do so, the service provider computer 204 and/or virtual pharmacy module 205 can examine any destination ID included with the electronic prescription 302. For example, there may be one or more destination IDs that are predefined to be associated with a virtual pharmacy. For example, a virtual pharmacy may be a non-dispensing pharmacy that is associated with a particular NPI code or other pharmacy identifier. If a particular NPI code or other pharmacy identifier associated with a non-dispensing pharmacy is included with the prescription 302, then block 410 may determine that the electronic prescription 302 is destined for a virtual pharmacy. On the other hand, if the NPI code or other identifier associated with a dispensing pharmacy is included with the prescription 302, then block 410 may determine that the electronic prescription 302 is not destined for a virtual pharmacy. It will be appreciated that the database 242 can include a look-up table for determining whether a destination ID is associated with a virtual pharmacy or a non-dispensing pharmacy, according to an example embodiment of the invention. It will also be appreciated that other fields besides a destination ID can be used to indicate whether an electronic prescription 302 is destined for a virtual pharmacy, according to an example embodiment of the invention.

If block 410 determines that the electronic prescription 302 is not destined for a virtual pharmacy, then the electronic prescription 302 may instead be destined for an actual/dispensing pharmacy such that no services of the virtual pharmacy may be needed, and processing may proceed to block 415. At block 415, the service provider computer 204 and/or virtual pharmacy module 205 can deliver the prescription 302, or at least a portion of the information contained therein, as a prescription 304 to an actual/dispensing pharmacy 120a-n. The actual/dispensing pharmacy 120a-n can be a retail pharmacy, a mail-order pharmacy, a pharmacy vending machine, or any other pharmacy that can dispense the drugs or products requested by the prescription 304. For example, the service provider computer 204 can deliver an electronic prescription 304 as a healthcare transaction request in an e-prescribing script format such as a National Council for Prescription Drug Programs (NCPDP) SCRIPT form, an Electronic Data Interchange (EDI) ANSI format, an HL7 format, or the like, as described herein. Alternatively, the service provider computer 204 can deliver the electronic prescription 304 for receipt by a facsimile or electronic device 312 of the pharmacy 120a-n. Once the prescription 304 has been received by the pharmacy 120a-n, the pharmacy 120a-n may fill the prescription 304 by packaging requested drugs or products for pick-up by or delivery to the patient 115. If the prescription 304 is a legal prescription delivered to the pharmacy 120a-n, then the patient 115 may not need to provide any other prescription to receive the requested drug or product. On the other hand, if the prescription 304 is a copy or image of a paper prescription, then the patient 115 may need to provide or present the actual paper prescription to a pharmacy 120a-n in order to receive the requested drug or product.

On the other hand, block 410 may determine that the electronic prescription 302 is destined for a virtual pharmacy, and processing may proceed to block 420. At block 420, the patient 115 corresponding to the electronic prescription 302 may be identified. For example, the patient 115 may be identified by matching patient information (e.g., name, date of birth, cardholder ID) included in the electronic prescription 302 with corresponding information available to the service provider computer 204 and/or virtual pharmacy module 205. As an example, a patient 115 may have previously completed an Internet-based registration, a telephone-based registration, or a paper-based registration in order to register for access to the services of a virtual pharmacy, and one or more registration records may be stored, perhaps in database 242 or another data storage/network location for subsequent access. Accordingly, one or more records may be available to the service provider computer 204 and/or virtual pharmacy module 205 in order to identify the patient 115 corresponding to the electronic prescription 302 and/or the virtual pharmacy module 205 can fax the prescription 304 for receipt by a facsimile. The identification of the patient 115 at block 420 may support additional identification of other supporting patient information for use with the services of a virtual pharmacy, according to an example embodiment of the invention.

Following block 420 is block 422. At block 422, the service provider computer 204 and/or virtual pharmacy module 205 may identify any healthcare plan available to the patient 115. In an example embodiment of the invention, an available healthcare plan can be an existing healthcare plan that the patient 115 is currently enrolled in or covered under. Alternatively, an available healthcare plan can also be one that the patient is not currently enrolled in or covered under, but that the patient 115 may be eligible for or interested in enrolling in. A healthcare plan can include an insurance plan, a discount plan, a buyer's club, or the like, according to an example embodiment of the invention. The identified healthcare plans may be used to identify one or more “in-network” dispensing pharmacies 120a-n that may be available to the patient 115.

Following block 422 is block 425. At block 425, the service provider computer 204 and/or virtual pharmacy module 205 can determine patient pharmacy location preferences of the patient 115. In an example embodiment of the invention, the pharmacy location preferences may have been previously received from the patient 115 and stored in a record, perhaps in database 242, in association with patient identification information, according to an example embodiment of the invention. Accordingly, if the pharmacy location preferences are available in a record, the service provider computer 204 and/or virtual pharmacy module 205 can retrieve the pharmacy location preferences from the stored record using patient identification information (e.g., name, date of birth, location information, etc.). The pharmacy location preferences stored in the record may indicate any of the following:
Specific Preferred Pharmacy(ies): Specifically identities one or more particular dispensing pharmacies 120a-n that are preferred by the patient 115. The particular dispensing pharmacies 120a-n can include one or more retail pharmacies or mail-order pharmacies. A retail pharmacy can be associated with a physical location at which the patient 115 can pick up one or more prescribed drugs or products. A mail-order pharmacy can mail or deliver the prescribed drug or product to a location of the patient 115.
Specified Location and Distance/Radius: Specifies an address, or any portion thereof (e.g., a zip code), for purposes of locating dispensing pharmacies 120a-n within proximity to the specified address or portion thereof. To determine the proximity, a radius can also be specified to indicate a distance from the specified address or portion thereof. The specified address or portion thereof can be either a patient 115 address or an address of a healthcare provider 110 (e.g., physician). If the address of the healthcare provider is to be used, it can alternatively be obtained from an electronic prescription at the time the electronic prescription 302 is received by the virtual pharmacy 105.

It will be appreciated that in some instances, the pharmacy location preferences are either not available, or may otherwise specify a location that needs to be obtained from the patient 115. For example, the pharmacy location preferences can specify a current location that needs to be obtained from the patient 115. In this case, the service provider computer 204 and/or virtual pharmacy module 205 may deliver a request 320 for a location to a patient device/computer 206 of the patient 115. In an example embodiment of the invention, the request 320 may request a current location of the patient 115. The current location may be global positioning system (GPS) coordinates associated with the patient device/computer 206. Alternatively, the current location may be one that is entered by a patient 115 using an I/O interface 262 (e.g., keypad, touch screen, etc.) of the patient device/computer 206. For example, a patient 115 can enter a location such as a street address, city, state, and/or zip code, or any portion thereof. The patient 115 can also enter a specified distance/radius from the specified location. The patient device/computer 206 can deliver the location information in a response 322 to the service provider computer 204 and/or virtual pharmacy module 205. Accordingly, at block 425, the service provider computer 204 and/or virtual pharmacy module 205 can determine the patient pharmacy location preferences. It will be appreciated that any number of requests 320 and responses 322 can occur interactively between the service provider computer 204 and/or the virtual pharmacy module 205 and the patient 115 without departing from example embodiments of the invention. Likewise, the requests 320 and responses 322 can occur in real-time in order to facilitate the provision of services of a virtual pharmacy in accordance with example embodiments of the invention.

Following block 425 is block 430. At block 430, the service provider computer 204 and/or virtual pharmacy module 205 can determine actual/dispensing pharmacies that satisfy certain requirements, including for example, patient pharmacy location preferences. For example, the actual/dispensing pharmacies can include those dispensing pharmacies 120a-n preferred by the patient 115 and/or those dispensing pharmacies 120a-n within a certain radius or distance from a location associated with the patient 115 in accordance with the pharmacy location preference. The actual/dispensing pharmacies 120a-n can also include those pharmacies associated with a healthcare plan of the patient 115. Alternatively, the actual/dispensing pharmacies can further include those dispensing pharmacies 120a-n outside of a healthcare plan of the patient 115 as well, as discussed with respect to block 422, without departing from example embodiments of the invention. By including those dispensing pharmacies 120a-n outside of a healthcare plan of a patient 115, the patient may be able to consider enrolling in another healthcare plan if certain costs are lower in another healthcare plan.

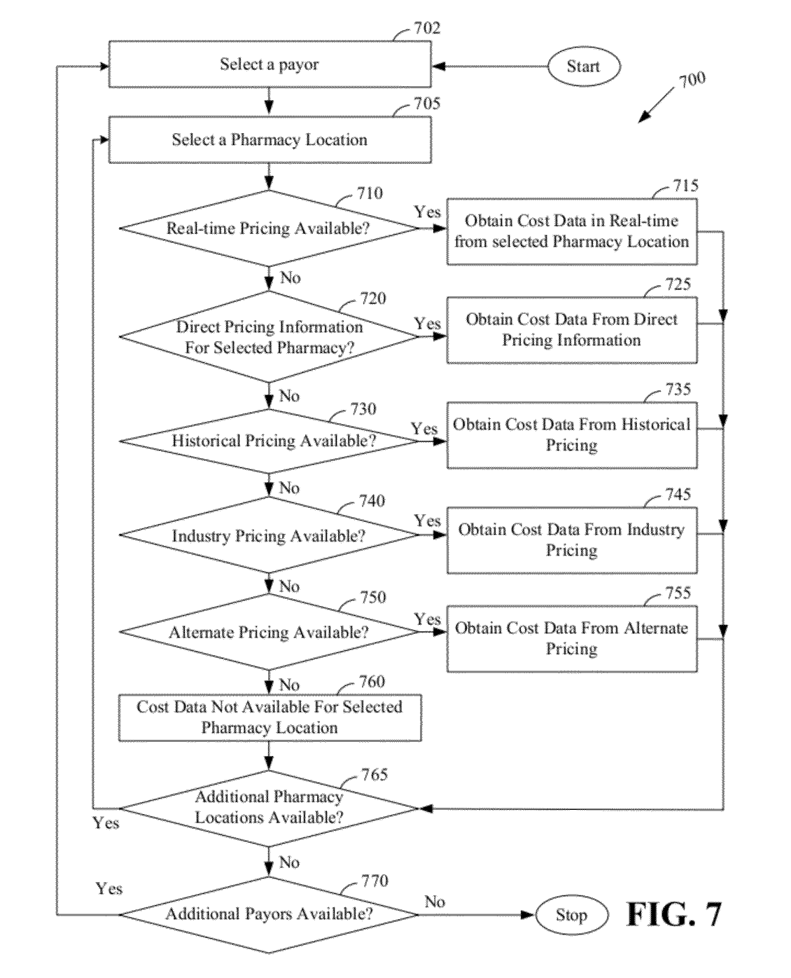

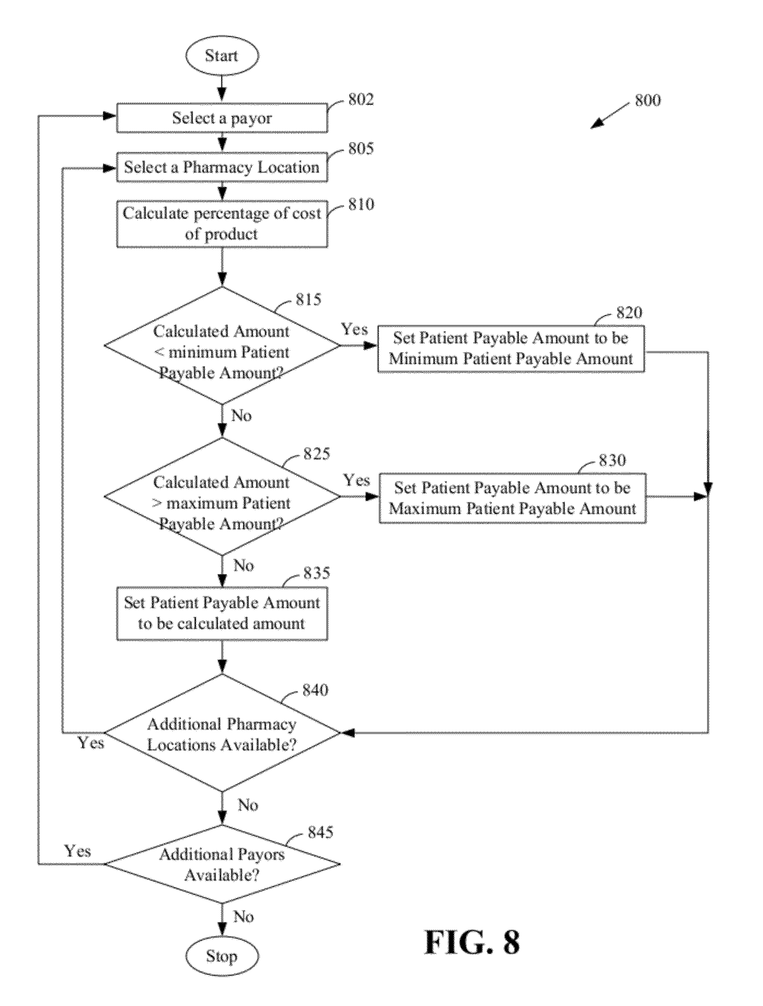

Following block 430 is block 435. At block 435 the service provider computer 204 and/or virtual pharmacy module 205 can perform a cost optimization based upon the one or more requested drugs or products and the one or more actual/dispensing pharmacies 120a-n identified for consideration from block 430. In particular, the example cost optimization of block 430 may include determining a price or cost of the requested drug or product at the identified actual/dispensing pharmacies 120a-n. The price or cost can represent a total price or a total cost payable to the identified actual/dispensing pharmacies 120a-n for providing the requested drug or product to the patient 115. The price or cost can also be apportioned between a first amount payable by a payor 125 of a healthcare plan of the patient 115, and a second amount payable by the patient 115 (e.g., a co-pay amount or co-insurance amount). FIG. 7, either alone or in conjunction with any of FIGS. 8-10, may illustrate an example implementation for block 435, according to an example embodiment of the invention. It will be appreciated that the determination of prices or costs in accordance with block 435 may enable the virtual pharmacy to inform the patient 115 about the prices or costs of filling a prescription at various dispensing pharmacies 120a-n, thereby allowing a patient 115 to make an informed decision by having knowledge of these respective total costs. It will be appreciated that in some example embodiments, a prescription 302 may identify a plurality of requested drugs or products. In that case, there may be a total price or cost (and/or respective patient payable amounts) determined for each drug or product at each dispensing pharmacy 120a-n, according to an example embodiment of the invention. In addition, the total price or cost determined for each drug or product can also be accumulated or aggregated to provide cumulative total price or cost (and/or cumulative patient payable amounts) for filling the prescription for all the requested drugs or products at each dispensing pharmacy 120a-n. It will also be appreciated that the total prices or costs for filling a prescription at each dispensing pharmacy 120a-n may differ depending upon the payor 125 under consideration. For example, certain payors 125 may have different negotiated rates with certain dispensing pharmacies 120a-n, or even if the rates are the same, the patient payable amounts may differ from payor to payor. Accordingly, it may be necessary at block 435 to determine, for each payor 125, respective prices or costs for filling a prescription at the one or more dispensing pharmacies 120a-n. Likewise, as described herein, block 435 may also determine cash costs or prices for filling prescriptions at one or more pharmacies 120a-n, according to an example embodiment of the invention.

Following block 435 is block 440. At block 440, the service provider computer 204 and/or virtual pharmacy module 205 can determine whether any incentives (or penalties) are available for filling the prescription at any of the identified dispensing pharmacies 120a-n. In general, the incentives for block 440, and the eligibility rules associated therewith, may be specified or sponsored by a payor 125 (e.g., an insurance company), an employer, a pharmacy, or another entity. The incentives or penalties/disincentives may be based upon whether the requested drug or product is for an acute condition or for a chronic condition. For example, it may be more desirable to drive a patient 115 to a lower-cost pharmacy 120a-n for obtaining a drug or product for a chronic condition (e.g., diabetes, chronic obstructive pulmonary disorder (COPD), asthma, seasonal allergies, etc.), as compared to an acute condition (e.g., a cold or the flu). These incentives may include financial incentives (e.g., rebates, discounts, reduced co-pays or co-insurance amounts), points, social incentives (e.g., social recognition), or yet other incentives, according to an example embodiment of the invention. It will be appreciated that many incentives are available without departing from example embodiments of the invention. Accordingly, block 440 may determine whether any incentives (or penalties) are available for filling the prescription at any of the identified actual/dispensing pharmacies 120a-n.

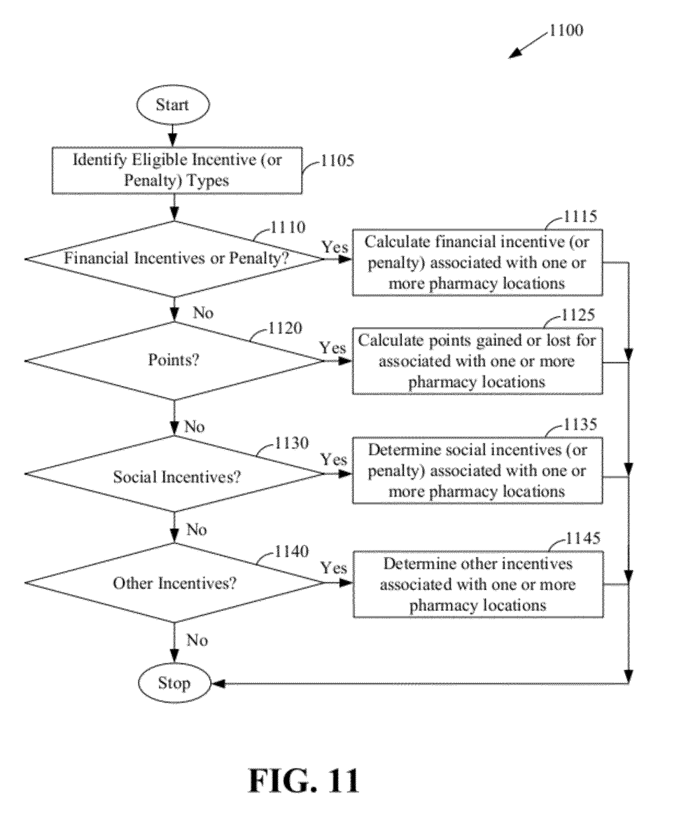

If block 440 determines that any incentives or penalties apply, then processing may proceed to block 445. Block 445 may calculate an extent to which any incentives or penalties apply for filling the prescription at one or more identified actual/dispensing pharmacies 120a-n. For example, block 445 can determine a monetary amount of any financial incentives (or penalties) that apply for filling the prescription at one or more dispensing pharmacies 120a-n. Likewise, block 445 can also determine a number of points that are to be gained or lost for filling a prescription at one or more dispensing pharmacies 120a-n. For social incentives, block 445 can determine which social indicia (e.g., badges, etc.) or public recognition (e.g., in a listing, newsletter, etc.) may be available for filling a prescription at one or more dispensing pharmacies 120a-n. An example implementation for block 445 will be discussed in further detail with respect to FIG. 11.

Following block 445 is block 450. Block 450 can also be reached if block 440 determines that no incentives or penalties apply. At block 450, the service provider computer 204 and/or virtual pharmacy module 205 can prepare information 324 identifying pharmacies for consideration by the patient 115. The information 324 can include not only a list of pharmacies, but also one or more of the associated information:
Address or location information (or geographical map) associated with each dispensing pharmacy 120a-n, or a network link for obtaining the address or location information (or geographical map) associated with each pharmacy. The address or location information can also identify a distance from a desired location, as specified by the pharmacy location preferences of the patient 115.
Price or cost associated for filling the prescription and receiving the drug(s) or product(s) from each dispensing pharmacy 120a-n, including a total price or cost payable to each dispensing pharmacy 120a-n, a patient payable amount, and/or a payor payable (or covered) amount; and/or
Any incentives or penalties/disincentives that apply for filling the prescription and receiving the drug or product from one or more dispensing pharmacies 120a-n. There may be one or more indicia, symbols, or the like, and optionally color codes, to indicate that certain incentives or penalties/disincentives may apply to a particular dispensing pharmacy 120a-n. For example, there may be a green “check” mark indicating that an incentive applies to a particular dispensing pharmacy 120a-n, and a red “X” mark indicating that a penalty/disincentive applies to a particular dispensing pharmacy 120a-n, according to an example embodiment of the invention. It will be appreciated that the amount of the incentive or penalty/disincentive can be included, or simply a link (e.g., URL) to the amount of the incentive or penalty/disincentive that may be provided, according to an example embodiment of the invention.

It will be appreciated that the service provider computer 204 can deliver the information 324 that includes the list of dispensing pharmacies 120a-n and associated information to the patient device/computer 206. In some example embodiments, it may be desirable to prioritize or restrict the listing of dispensing pharmacies 120a-n for presentation or display on the patient device/computer 206. In some example embodiments of the invention, the prioritization may be based upon a consideration of one or more combinations of the following factors:
Distance of pharmacy from the location associated with the patient 115
Price or cost associated for filling the prescription and receiving the drug or product from each pharmacy. With respect to price or cost, it can be a total price or cost payable to the pharmacy, a patient payable amount, and/or a payor payable (or covered) amount
One or more preferred pharmacies specified by the patient 115
   As an example, a predetermined number of pharmacies may be prioritized on the list higher based upon distance as a primary consideration, and price or cost as a secondary consideration. Alternatively, one or more pharmacies on the list may be prioritized based upon price or cost as the sole or primary consideration, and distance as a secondary consideration. In some example embodiments of the invention, the total price or cost may be solely considered in order to manage the total costs of healthcare for all participants (e.g., patient, payor, employers, etc.). In another embodiment, the price or cost may be a patient payable amount in order to manage the patient's 115 costs. In yet another embodiment, the price or cost may be a payor payable (or covered) amount in order to manage the payor's 125 (and ultimately, the employer's) prices or costs. Accordingly, if a prioritization is utilized, then information 324 can include only a portion of a list of dispensing pharmacies 120a-n and associated information to the patient device/computer 206. However, the patient device/computer 206 may request additional information 324 (e.g., clicking “more” or another similar button) to obtain the full list of available pharmacies and associated information. In addition or in the alternative, the list of dispensing pharmacies 120a-n can also be restricted based on a desired number of pharmacy 120a-n locations for display on the patient device/computer 206, which may be set by preferences of a service provider or a patient 115, according to an example embodiment of the invention.

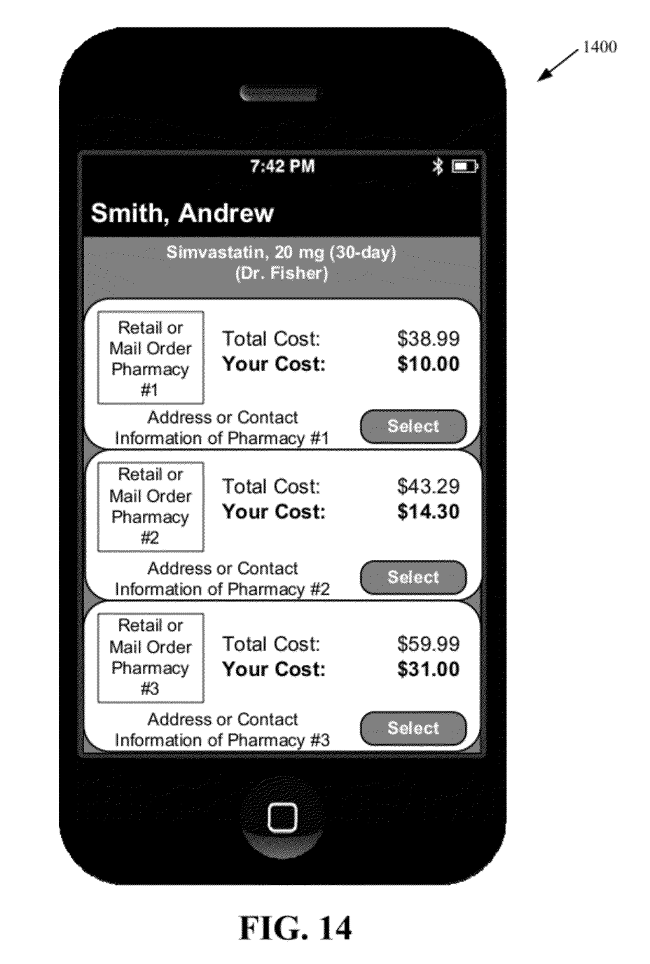

Upon receipt of the information 324 at block 450, the patient device/computer 206 may present the information 324 for viewing by the patient 115. For example, FIG. 14 illustrates an example user interface 1400 of software used on a patient device/computer 206 that is a mobile device, smart phone, or personal communications device. As shown in the example user interface 1400, there is displayed or presented a list of pharmacies in conjunction with associated information that includes: (i) address or contact information for each dispensing pharmacy 120a-n, (ii) total price or cost information (e.g., Total Cost) for each dispensing pharmacy 120a-n, and (iii) patient payable cost (e.g., Your Cost) for each dispensing pharmacy 120a-n. It will be appreciated that if multiple drugs or products were included with a prescription 302, the total price or cost information for a particular pharmacy 120a-n could be an aggregate or accumulated total price or cost based upon aggregating respective costs for each drug or product at the particular pharmacy 120a-n. In addition, the user interface 1400 may include one or more selection buttons or indicators that allow a patient 115 to select at least one of the pharmacies for filling the prescription, according to an example embodiment of the invention. It will be appreciated that many variations of the user interface 1400 are available without departing from example embodiments of the invention. For example, the user interface 1400 could have also shown incentive or penalty/disincentive information or utilized different color coding or other indicia to identify those pharmacies recommended or not recommended for selection. Likewise, the presentation could have also included travel directions or a geographical map, or a link (e.g., URL) to corresponding information, for one or more of the identified pharmacies, according to an example embodiment of the invention.

Following block 450 is block 455. At block 455 the service provider computer 204 and/or virtual pharmacy module 205 may receive a response 326 from the patient device/computer 206. The response 326 may include a pharmacy selection that indicates at least one dispensing pharmacy 120a-n selected by the patient 115. It will be appreciated that if the prescription 302 included a plurality of drugs or products, the response 326 may indicate either (i) one dispensing pharmacy 120a-n for filling the prescription 302 for all of the drugs or products; or (ii) two or more dispensing pharmacies 120a-n for filling respective drugs or products from the prescription 302, according to an example embodiment of the invention.

Following block 455 is block 460. At block 460, the service provider computer 204 and/or virtual pharmacy module 205 may determine whether any financial processing is available. To do so, the service provider computer 204 and/or virtual pharmacy module 205 may determine whether any of the associated entities are eligible for financial processing, including any of (i) the patient 115 associated with the prescription 302, (ii) a payor 125 or employer associated with the patient 115, and/or (iii) the actual/dispensing pharmacy 120a-n associated with the patient 115. For example, the patient 115 may have specified a preference, perhaps as part of a registration process or in conjunction with delivery of the prescription 302, as to whether or not the patient 115 wishes for any financial processing for any patient payable cost or amount to be performed or completed prior to the patient 115 arriving at a particular pharmacy 120a-n to pick up the requested drug or product. Alternatively, if the patient 115 is associated with a particular financial HSA/FSA identifiable by the service provider computer 204 and/or virtual pharmacy module 205, then financial processing may be available. Likewise, the selected pharmacy 120a-n may also have specified preferences, perhaps stored in database 242, indicating whether it wishes for the service provider computer 204 and/or virtual pharmacy module 205 to perform any financial processing on its behalf As an example, the service provider computer 204 and/or virtual pharmacy module 205 may facilitate adjudications of prescription claim transactions on behalf of a pharmacy 120a-n. Similarly, the payor or employer associated with the patient 115 may likewise have specified preferences, perhaps stored in database 242, indicating whether it wishes for the service provider computer 204 and/or virtual pharmacy module to perform any financial processing. In an example embodiment of the invention, one or more of these financial processing preferences may be stored, perhaps in database 242, in association with patient identification information for subsequent retrieval upon receipt of a prescription 302 associated with a patient 115.

If block 460 determines that financial processing is available, then processing may proceed to block 465. At block 465, the service provider computer 204 and/or virtual pharmacy module 205 can perform financial processing in a variety of ways. In an example embodiment, financial processing may include any of the following: (i) directing a prescription claim adjudication with a financial processing computer 208 that is a claims processor computer, (ii) preparing a payment authorization for the pharmacy 120a-n to charge or debit a financial instrument, or (iii) directing a debit transaction with a financial processing computer 208 (e.g., a credit/debit card network, ACH network, HSA/FSA processing network, etc.) to in order to cover payment of the patient payable cost from a financial instrument.

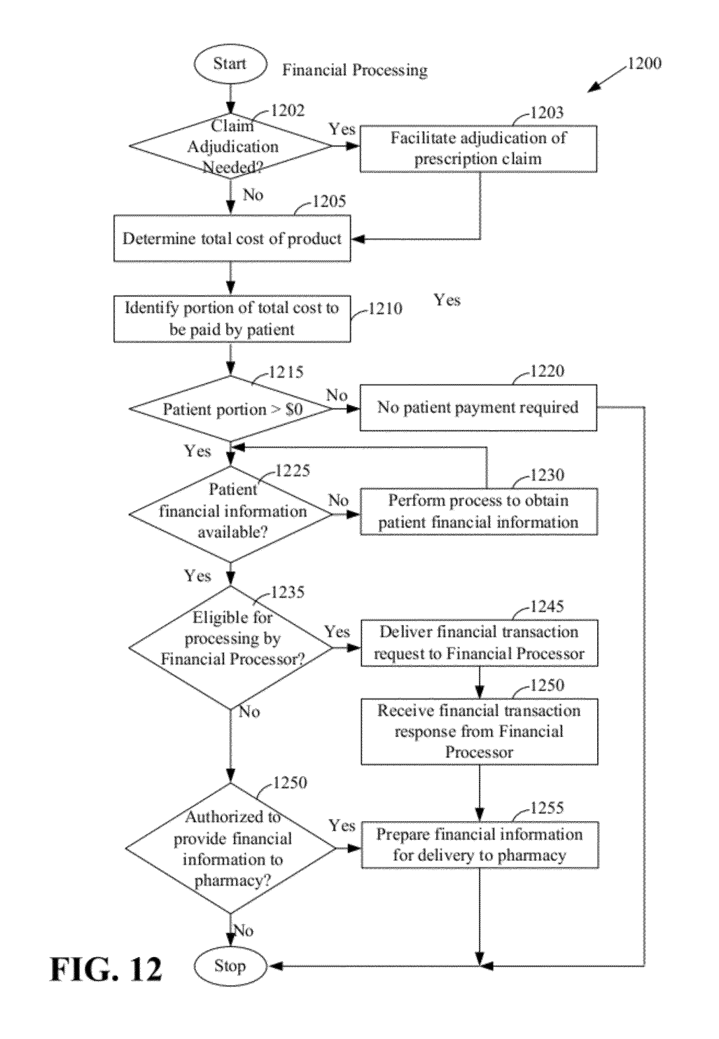

According to an embodiment, at block 465, the service provider computer 204 and/or virtual pharmacy module 205 can direct a prescription claim adjudication with a financial processing computer 208 that is a claims processor computer. The prescription claim adjudication may be associated with obtaining reimbursement from a third-party payor (e.g., insurance company, PBM, government payor (e.g., Medicaid, Medicare, etc.) for providing the requested drug or product to the patient 115. The directing of the prescription claim adjudication can include delivering a prescription claim 330 to the financial processing computer 208 (e.g., claims processor computer) to determine benefits and/or coverage. Following the adjudication of the prescription claim 330 by the financial processing computer 208, the service provider computer 204 and/or virtual pharmacy module 205 can receive an adjudication response 332. The adjudication response can generally identify a result of the adjudication by the financial processing computer 208. An example adjudication process will be discussed in further detail with respect to FIG. 12.

According to another example embodiment, at block 465, the service provider computer 204 and/or virtual pharmacy module 205 can additionally or alternatively prepare a payment authorization for the pharmacy 120a-n to charge or debit a financial instrument. For example, the service provider computer 204 and/or virtual pharmacy module 205 can prepare a financial processing authorization form or similar information for delivery to the pharmacy 120a-n. The financial processing authorization form can include information identifying a financial instrument of the patient 115 (e.g., an account number or card number), as well as an authorization to charge or debit the financial instrument. The financial instrument can be associated with a deposit account (e.g., checking account, savings account, etc.), credit/debit card account, FSA/HSA, or other monetary account.

In yet another example embodiment, at block 465, the service provider computer 204 and/or virtual pharmacy module 205 can direct a debit transaction with a financial processing computer 208 in order to cover payment of a patient payable cost from a financial instrument. In this case, the financial processing computer may be associated with a financial transaction network such as a credit/debit card network (e.g., VISA, MasterCard, American Express, etc.), an ATM/debit card processing network, an ACH network, a HSA/FSA processing network, or a similar network for flexible spending/healthcare savings accounts or other monetary transaction accounts.

For example, the service provider computer 204 and/or virtual pharmacy module 205 can interact with a financial processing computer 208 to perform the financial processing at block 465. For example, the service provider computer 204 and/or virtual pharmacy module 205 can deliver a financial transaction request 334 to the financial processing computer 208. The financial transaction request 334 can identify a financial instrument of the patient 115 as well as an amount of the patient payable cost to debit or apply to the financial instrument. Upon processing the financial transaction request 334 by the financial processing computer 208, the financial processing computer 208 may deliver a financial transaction response 336 to the service provider computer 204 and/or virtual pharmacy module 205. The financial transaction response 336 may indicate whether the amount of the patient payable cost was successfully debited from or applied to the financial instrument, according to an example embodiment of the invention.

In an example embodiment of the invention, the financial processing can result in payments being delivered directly to an account of the pharmacy 120a-n to cover a total amount payable to a pharmacy 120a-n for providing the requested drug or product to the patient 115. For example, the adjudication of the prescription claim 330 or the financial transaction request 334 can result in the payments being credited to an account of the pharmacy 120a-n. Alternatively, one or more of the payments can be received by or credited to an account associated with the service provider, and the service provider can deliver at least a portion of the received payments to an account of the pharmacy 120a-n. In an example embodiment of the invention, these received payments can be aggregated and delivered to an account of the pharmacy 120a-n in accordance with a periodic settlement or reconciliation process.

Following block 465 is block 470. At block 470, the service provider computer 204 and/or virtual pharmacy module 205 can prepare a transaction request 304 to the pharmacy 120a-n. The transaction request 304 can include a copy of the prescription 302, as well as any financial processing information resulting from processing at block 465. It will be appreciated that the types of financial processing information included in the transaction request 304 can vary depending upon the types of financial processing information performed at block 465. For example, the financial processing information can indicate whether any prescription claim 330 had been prepared or adjudicated, as well as any result of the adjudication obtained from the response 332. Likewise, the financial processing information can include a payment authorization for the pharmacy 120a-n to charge or debit a financial instrument. The financial processing information could also indicate whether a financial transaction request 334 was processed by a financial processing computer 208 (e.g., a credit/debit card network, ACH network, HSA/FSA processing network, etc.) in order to cover payment of the patient payable cost from a financial instrument, as well as any result of the processing from the response 336.

In addition, it will be appreciated that one or more transaction responses can also be delivered by the service provider computer 204 and/or the virtual pharmacy module 205 to the healthcare provider 110 or the patient 115, according to an example embodiment of the invention. For example, a transaction response delivered to the healthcare provider 110 or the patient 115 may indicate whether a prescription 302 was successfully received, as well as a confirmation of delivery of the prescription 304 (and/or any financial processing) to a dispensing pharmacy 120a-n.

It will be appreciated that the processing of the blocks in FIG. 4 can be performed in real-time, according to an example embodiment of the invention. For example, once the service provider computer 204 and/or virtual pharmacy module 205 receives the prescription 302 and determines that the virtual pharmacy is designated, it may trigger a real-time interactive process with the patient 115 and/or the financial processing computer 208. In this way, the necessary information can be quickly received from the patient 115 and/or the financial processing computer 208 so that the transaction request 304 having the prescription can be delivered to the selected pharmacy 120a-n.

Capturing Electronic Prescription

FIG. 5 illustrates an example process 500 for generating an image of a paper prescription, according to an example embodiment of the invention. One or more blocks of the example process 500 can be implemented as computer-executable instructions accessed and executed by a patient device/computer 206 to capture or generate an image of a paper prescription for delivery to a service provider computer 204 and/or virtual pharmacy module 205. Accordingly, the service provider computer 204 and/or virtual pharmacy module 205 can receive a prescription 302 from a patient device/computer 206, as discussed in block 405 of FIG. 4.

In an example embodiment of the invention, the computer-executable instructions associated with one or more blocks of the example process 500 may be software in the form of a mobile application downloaded by the patient 115 for the patient device/computer 206. As an example, the mobile application may have been downloaded in conjunction with patient registration for one or more services of a virtual pharmacy. The mobile application could also be downloaded from a website of a healthcare provider or a service provider. Alternatively, the computer-executable instructions could also be in the form of applets, forms, or other software accessed or downloaded via an Internet browser at an Internet website. Indeed, the computer-executable instructions for one or more blocks of the example process 500 may be available from a variety of network sources without departing from example embodiments of the invention. It will also be appreciated that one or more blocks of the example process 500 can also be performed by a service provider computer 204 and/or virtual pharmacy module 205 that processes the received prescriptions, according to an example embodiment of the invention.

In utilizing the mobile application, software, or other computer-executable instructions, the patient device/computer 206 can authenticate with the service provider computer 204 and/or virtual pharmacy module 205, or another computer (e.g., web server) associated therewith. The authentication may enable the service provider computer 204 and/or virtual pharmacy module 205 to identify the patient 115 who is providing the image of a prescription, according to an example embodiment of the invention.

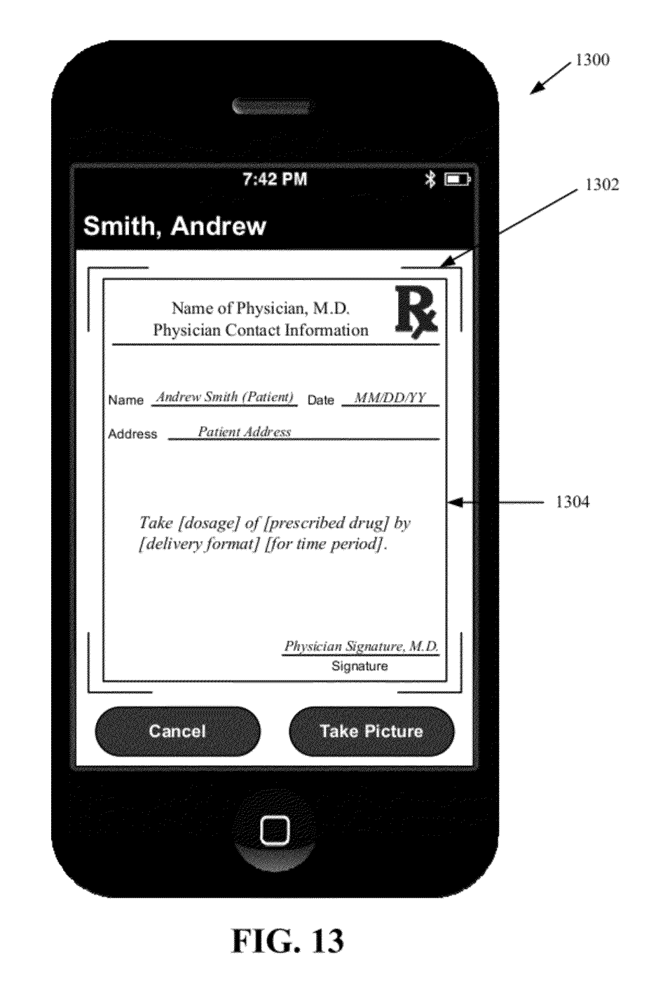

Turning now to FIG. 5, the example process 500 may begin with block 505. Block 505 may be triggered or executed in response to a patient 115 directing a mobile application, software, or other computer-executable instructions on the patient device/computer 206 to capture an image or a picture of a paper prescription. For example, the patient 115 may make a selection or otherwise enable image capture functionality like “Capture image of prescription” on the patient device/computer 206. At block 505, the camera or other image capture device (e.g., scanner) of the patient device/computer 206 may be enabled, and the patient 115 may be presented with the example user interface, such as the interface 1300 shown in FIG. 13, for use in capturing an image of a paper prescription.

Following block 505 is block 510, where the patient 115 can use the camera or other image capture device of the patient device/computer 206 to capture an image of the paper prescription. For example, the user interface 1300 may include guidelines 1302 for helping a patient 115 position or size an image 1304 of the paper prescription within the user interface 1300. The patient 115 can then click a button or other indicator on the user interface 1300 to capture an image 1304 of the paper prescription. The image 1304 of the paper prescription may be a photograph of the paper prescription. It will be appreciated that the captured image 1304 of the paper prescription may include typical information included on a paper or electronic prescription, as described herein. For example, the information can identify a patient and prescribing physician or other prescriber, as well as contact information associated therewith. The prescription can also include information about the prescribed drug or product, including quantity, form/dosage, dispensing instructions, number of refills, etc. Many variations of prescription information are available without departing from example embodiments of the invention.

Following block 510 is block 515. At block 515, the image 1304 can be delivered to the service provider computer 204 and/or virtual pharmacy module 205. Accordingly, the service provider computer 204 and/or virtual pharmacy module 205 can receive a prescription 302 comprising the image 1304, which can be in the form of an image file or the like that is communicated via Internet communications or other wired/wireless communications (e.g., 3G, 4G, cellular, WiFi). It will be appreciated that the prescription 302 can also be delivered with location information (e.g., GPS coordinates or patient provided location information) from the patient device/computer 206 to the service provider computer 204 and/or virtual pharmacy module 205.

Following block 515 is block 520. At block 520, the service provider computer 204 and/or virtual pharmacy module 205 can process the received image 1304 to determine whether any information is missing or illegible. In an example embodiment of the invention, block 520 may include performing optical character recognition (OCR) on the image 1304 to obtain prescription information in order to determine whether all required information for the prescription 302 is retrieved from the image 1304. As an example, the required information may include certain drug or product information, or other information associated with the patient or the prescriber. If block 520 determines that the received image 1304 is acceptable or that no missing or illegible information has been identified, then processing may proceed to block 550. At block 550, the service provider computer 204 and/or virtual pharmacy module 205 can accept the image 1304 as electronic prescription 302, and processing may proceed to block 555. At block 555, the service provider computer 204 and/or virtual pharmacy module 205 can deliver a transaction response to the patient device/computer 206, where the transaction response can indicate acceptance of the image 1304 as prescription 302.

If any of the required information is determined to be missing or illegible at block 520, then processing may proceed to block 525. Block 525 may determine whether the missing or illegible information can be corrected by the patient or the healthcare provider (e.g., prescriber). If block 525 determines that the missing or illegible information cannot be corrected, then the received image 1304 may not be acceptable and another image may be needed. In this case, processing may proceed to block 530, where a determination may be made as to whether the maximum number of attempts have been made to obtain another image 1304 of a paper prescription. If the maximum number of attempts have not been made, then processing may proceed to block 535, where a request may be delivered to the patient device/computer 206 to take a new picture or image of the paper prescription. Processing can then restart at block 505, as discussed above.

On the other hand, block 530 may determine that the maximum number of attempts have been made to obtain another image 1304 of a paper prescription, and processing may proceed to block 555. At block 555, a transaction response may be delivered to the patient device/computer 206, where the transaction response may indicate that an image of the paper prescription was not successfully captured as the electronic prescription 302. The transaction response may also indicate any available alternatives for submitting or faxing the paper prescription.

Returning back to block 525, a determination may be made that the information is correctable or confirmable (or can otherwise be supplied) by the patient or the healthcare provider, and processing may proceed to block 540. At block 540, the service provider computer 204 and/or virtual pharmacy module 205 can communicate with the healthcare provider 110 and/or the patient 115, depending upon the information that needs to be confirmed, corrected, or supplied. For example, prescription drug or product information, such as dosage or dispensing instructions, may be correctable or confirmable by a healthcare provider 110. On the other hand, patient information like contact information, location information, or the like can be correctable by the patient 115. The service provider computer 204 and/or virtual pharmacy module 205 can communicate with a respective computer 202, 206 of the respective healthcare provider 110 or patient 115. For example, the service provider computer 204 and/or virtual pharmacy module 205 can deliver, to the healthcare provider computer 202, an electronic request or message (e.g., email, text message, real-time messaging notification, instant message, etc.) to correct, confirm, or otherwise supply certain information. The healthcare provider 110 can then utilize an Internet browser or other software application to correct, confirm, or otherwise supply certain information to the service provider computer 204 and/or virtual pharmacy module 205. Similarly, the service provider computer 204 and/or virtual pharmacy module 205 can deliver, to the patient device/computer 206, an electronic request or message (e.g., email, text message, real-time messaging notification, instant message, etc.) to correct, confirm, or otherwise supply certain information, including any missing or illegible information. Alternatively, the patient device/computer 206 can also receive an electronic request or message requesting permission from the patient 115 for a service provider to contact the prescriber or other healthcare provider for the missing or illegible information. As an example, the service provider computer 204 and/or virtual pharmacy module 205 can communicate with a mobile application of the patient device/computer 206 to present a request that information in the image 1304 needs to be corrected, supplied, or confirmed prior to acceptance of the image 1304 as the prescription 302. In the response to the request, the patient 115 or the healthcare provider 110 can provide a response to the service provider computer 204 and/or virtual pharmacy module 205 to correct, supply, or confirm certain information, according to an example embodiment of the invention.

It will be appreciated that a variety of other communication means may be utilized at block 540 for communications between the service provider computer 204 and/or virtual pharmacy module 205 and either the healthcare provider 110 or the patient 115. For example, the healthcare provider 110 or the patient 115 could alternatively receive and transmit communications via respective facsimiles/electronic devices 310, 311, according to an alternative embodiment of the invention.

Following block 540 is block 545. Block 545 may determine whether the received information that was corrected, supplied or confirmed is complete. If not, processing may return to block 540, where the service provider computer 204 and/or virtual pharmacy module 205 can communicate with the healthcare provider 110 and/or the patient 115, depending upon the information that needs to be confirmed, corrected, or supplied.

On the other hand, block 545 may determine that the received information is complete, and processing may proceed to block 550. At block 550, the service provider computer 204 and/or virtual pharmacy module 205 can accept the image 1304 as prescription 302, and processing may proceed to block 555. At block 555, the service provider computer 204 and/or virtual pharmacy module 205 can deliver a transaction response to the patient device/computer 206, where the transaction response can indicate acceptance of the image 1304 as prescription 302.

Many variations of the example process 500 are available without departing from example embodiments of the invention. According to one variation, blocks 520, 525, 530, and 535 may alternatively be performed locally by the patient device/computer 206. In this variation, block 515 may be performed following the satisfaction of block 525 such that the image 1304 of the paper prescription is not delivered to the service provider computer 204 and/or virtual pharmacy module 205 until after the preliminary checks are completed.

Pharmacy Location Preferences

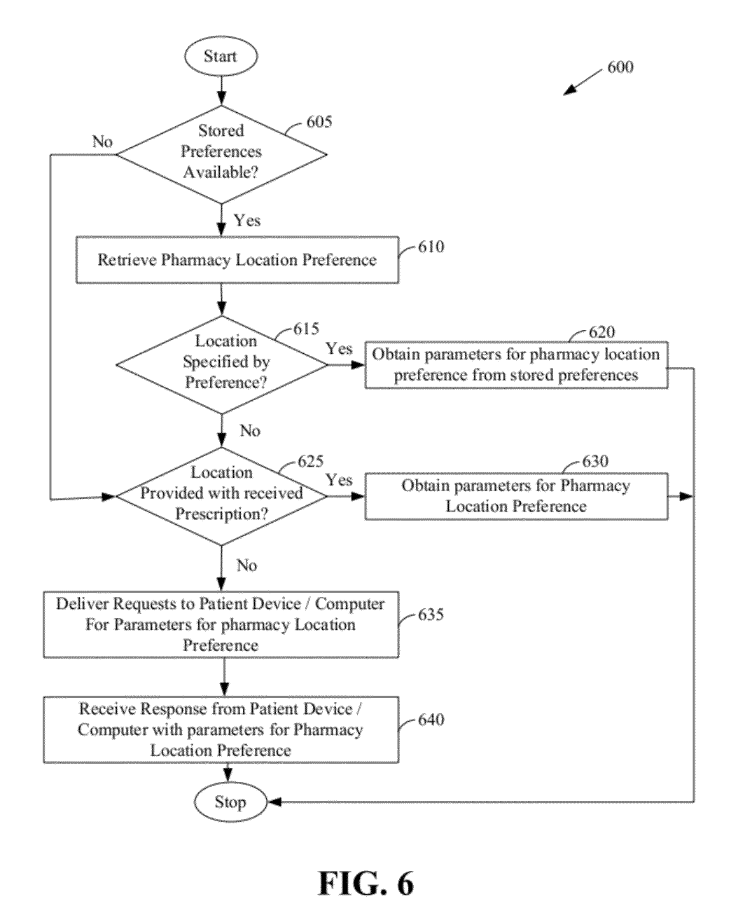

FIG. 6 illustrates an example process 600 for determining a pharmacy location preference of a patient, according to an example embodiment of the invention. It will be appreciated that one or more blocks of the example process 600 can be implemented as computer-executable instructions accessed and executed by a service provider computer 204 and/or virtual pharmacy module 205. In an example embodiment of the invention, the example process 600 can be an example implementation for block 425 of FIG. 4. Accordingly, it will be appreciated that the determination of pharmacy location preferences of the patient in the example process 600 may be utilized to identify one or more actual/dispensing pharmacies for subsequent presentation to the patient for selection.

Turning now to FIG. 6, the process 600 may begin with block 605. At block 605, the service provider computer 204 and/or virtual pharmacy module 205 may determine whether stored pharmacy location preferences are available that may specify the pharmacy location preferences of the patient 115. These stored preferences may have been received as part of a registration process for a patient 115, or during a configuration or setup process with the patient 115. In addition, these stored pharmacy location preferences may be stored, perhaps in database 242, in association with patient identification information. Accordingly, the service provider computer 204 and/or virtual pharmacy module 205 can determine whether the pharmacy location preferences are available based upon the identification of the patient 115.

If block 605 determines that the stored pharmacy location preferences are available, then processing may proceed to block 610, where the service provider computer 204 and/or virtual pharmacy module 205 retrieves the stored pharmacy location preferences. In an example embodiment of the invention, the stored pharmacy location preferences can specify actual/dispensing pharmacies or locations for searching for actual/dispensing pharmacies. For example, the stored pharmacy location preferences can specify one or more particular dispensing pharmacies or dispensing pharmacy locations that are preferred by the patient 115. The particular dispensing pharmacies can include one or more retail pharmacies or mail-order pharmacies. On the other hand, the stored pharmacy location preferences can specify a location and a distance/radius from the specified location. The specified location can be based upon a street address, city, county or the like. Alternatively, the specified location can be set to automatically use a current location corresponding to GPS coordinates associated with the patient device/computer 206. In other example embodiments, the stored pharmacy location preferences can indicate that the patient 115 wishes to use a current location that will be specified by the patient 115 upon a request being delivered to the patient device/computer 206.

Following block 610 is block 615. Block 615 may determine whether the pharmacy location preferences provide sufficient information for identifying locations of actual/dispensing pharmacies. If so, processing may proceed to block 620. At block 620, the parameters for the pharmacy location preferences may be obtained from the stored preferences. For example, block 620 can include obtaining locations of any particular pharmacies that are preferred by the patients. Block 620 can also include obtaining the location and radius parameters from the stored preferences for use in a search for actual/dispensing pharmacies within the location and radius. As an alternative, if the stored preferences specify the use of a current location corresponding to GPS coordinates, then block 620 can also include obtaining the GPS coordinates, and the service provider computer 204 and/or the virtual pharmacy module 205 may communicate with the patient device/computer 206 to obtain the GPS coordinates or similar information. It will be appreciated that in an example embodiment of the invention, GPS coordinates or similar information may likewise be translated or converted by the patient device/computer 206, the service provider computer 204, and/or virtual pharmacy module 205 into a street address or other location identifier without departing from example embodiments of the invention.

On the other hand, block 615 may determine that the stored pharmacy location preferences provide insufficient information for identifying locations of actual/dispensing pharmacies, and processing may proceed to block 625. Block 625 may determine whether the location preferences may have been received with the prescription 302. For example, the patient device/computer 206 may have locally stored location preferences that are transmitted in conjunction with the prescription 302 to the service provider computer 204 and/or virtual pharmacy module 205. Alternatively, the GPS coordinates or other current location information associated with the patient device/computer 206 may have been transmitted in conjunction with the prescription 302 to the service provider computer 204 and/or virtual pharmacy module 205. It will be appreciated that the location preferences, GPS coordinates, and/or other current location information may be included as part of the prescription 302, bundled with the prescription 302, or otherwise provided separately from the prescription 302, according to an example embodiment of the invention.

If the location preferences have been provided with the received prescription at block 625, processing may proceed to block 630. At block 630, the parameters for the pharmacy location preference may be obtained from the provided information. Block 630 may be similar to block 620, except that the information may be obtained from information provided with the prescription 302 instead of from stored pharmacy location preferences. It will be appreciated that variations of blocks 620 and 630 (and thus, blocks 615, 625) are available. For example, GPS coordinates for a current location may be received with the prescription 302, but the stored pharmacy location preferences may be used to obtain parameters for the desired radius from the received GPS coordinates. Many variations are available without departing from example embodiments of the invention.

If the location preferences have not been provided with the received prescription at block 625, or if a current location is needed, then processing may proceed to block 635. At block 635, the service provider computer 204 and/or virtual pharmacy module 205 can deliver a request to the patient device/computer 206 for the parameters specifying a pharmacy location preference or a current location. The patient device/computer 206 can present the request on the user interface of the patient device/computer 206, and the patient 115 can respond by providing, for example, a desired current location (e.g., street address, city, zip code, etc.) and radius/distance from the desired current location. Instead of providing a desired location, the patient 115 can also respond by authorizing the current GPS location to be transmitted along with a specified radius to the service provider computer 204 and/or virtual pharmacy module 205. At block 640, the service provider computer 204 and/or virtual pharmacy module 205 can receive the parameters specifying a pharmacy location preference or current location from the patient device/computer 206.

Cost Optimization

FIG. 7 illustrates an example cost optimization process 700 for determining a cost of filling a prescription at one or more dispensing pharmacies for a patient 115. In an example embodiment, the cost determined or obtained through the process 700 may be a total cost payable to the pharmacy for filling the prescription. For example, the total cost may be inclusive of any amounts payable by a third-party payor to a pharmacy and any amounts payable by a patient 115 to the pharmacy. In an alternative embodiment, the cost determined or obtained through the process 700 may be either an amount payable by a third-party payor or an amount payable by a patient 115. The cost data obtained from FIG. 7 may be used in providing cost information to a patient 115 to inform the patient of one or more costs of filling the prescription at one or more pharmacies. It will be appreciated that one or more blocks of the process 700 of FIG. 7 may be implemented as computer-executable instructions that are accessed and executed by the service provider computer 204 and/or virtual pharmacy module 205. In an alternative embodiment of the invention, one or more blocks of the process 700 may be implemented as computer-executable instructions that are accessed and executed by a patient device/computer 206 or another computer, according to an example embodiment of the invention. It will be appreciated that the example process 700 of FIG. 7 may be an example implementation for all or a portion of block 435 of FIG. 4.

The process 700 of FIG. 7 may begin with block 702. At block 702, there may be a variety of payors 125 available for the patient 115. These payors 125 can include an actual payor 125 of the patient 115, such as a current insurance company, PBM, or other payor providing coverage to the patient 115. However, the payors 125 can also include other payors that are not currently providing coverage for the patient 115, but that the patient 115 may consider enrolling with. The inclusion of other payors for the patient 115 may allow the patient 115 to compare price or cost information so that the patient 115 can consider switching to or enrolling with another payor 125 if appropriate. In some example embodiments, there may also be a “cash customer”, where the customer may not be utilizing a payor; however, this scenario may be considered as a payor under consideration so that the cash customer cost can likewise be determined at one or more pharmacies or pharmacy locations 120a-n, according to an example embodiment of the invention. Accordingly, at block 702, a payor can be selected for purposes of determining costs or prices for filling the prescription at one or more pharmacies.

Following block 702 is block 705. At block 705, there may be one or more pharmacies or pharmacy locations 120a-n for which associated costs or prices for filling a prescription need to be determined. The list of one or more pharmacies or pharmacy locations 120a-n may have been determined, for example, from block 430 in FIG. 4, according to an example embodiment of the invention. At block 705, one of the pharmacies or pharmacy locations 120a-n may be selected for purposes of determining an associated cost for filling the prescription at the selected pharmacy 120a-n.

Following block 705 may be one or more blocks for determining an associated cost or price for filling a prescription at the selected dispensing pharmacy 120a-n. These blocks can include blocks 710, 720, 730, 740, 750, 760 shown in FIG. 7, although fewer or more blocks may be utilized without departing from example embodiments of the invention. Likewise, the order or prioritization of blocks 710, 720, 730, 740, 750, 760 can likewise be varied depending on preferences for sources of cost data or prioritizations for sources of cost data.

In FIG. 7, block 710 may follow block 705. Block 710 may determine whether real-time pricing is available. The real-time pricing may be available from a variety of sources, including those associated with a pharmacy 120a-n or a payor 125. With real-time pricing, a service provider computer 204 and/or virtual pharmacy module 205 may communicate in real-time with a computer associated with a pharmacy 120a-n or a payor 125. Accordingly, block 710 may determine, based upon the selected pharmacy 120a-n or a payor associated with patient 115, whether real-time pricing is available.

If block 710 determines that real-time pricing is available, then processing may proceed to block 715. At block 715, the service provider computer 204 and/or virtual pharmacy module 205 may generate a healthcare transaction request (e.g., NCPDP transaction, EDI transaction, etc.) inquiring about a cost of filling a prescription at a pharmacy 120a-n. The healthcare transaction request can identify at least a requested drug or product and a dispense quantity. The healthcare transaction request can also identify a payor associated with the patient 115. The identity of the payor 125 may be relevant where a contracted rate for the drug or product has been negotiated between the payor 125 and the selected pharmacy 120a-n. The healthcare transaction request may be delivered from the service provider computer 204 and/or virtual pharmacy module 205 to a pharmacy computer 203 associated with the pharmacy or a financial processing computer 208 associated with the payor 125. The pharmacy computer 203 associated with the pharmacy 120a-n or the financial processing computer 208 associated with the payor 125 can process the healthcare transaction request and respond with a healthcare transaction response. The healthcare transaction response can indicate a total amount payable to the selected pharmacy 120a-n for filling the prescription for the patient 115. The healthcare transaction response can also allocate the total amount payable between a patient payable amount and another amount payable by the payor 125, according to an example embodiment of the invention.

Following block 715, processing may proceed to block 765, where a determination is made as to whether costs or pricing needs to be determined for any additional pharmacy locations 120a-n. If so, processing may return to block 705, where another pharmacy or pharmacy location 120a-n may be selected.

On the other hand, block 710 may determine that real-time pricing may not be available, and processing may proceed to block 720. Block 720 may determine whether direct pricing information is available for a selected pharmacy 120a-n. For example, block 720 may determine whether the selected pharmacy 120a-n, the payor 125, or another entity publishes pricing information on a publicly available website, or otherwise makes pricing information available via a network location. Alternatively, the pricing information may be stored locally, perhaps in database 242, or another data storage location accessible by the service provider computer 204 and/or the virtual pharmacy module 205.

If block 720 determines that the direct pricing information is available for a selected pharmacy 120a-n, then processing may proceed to block 725. At block 725, the service provider computer 204 and/or virtual pharmacy module 205 may obtain the cost data from the available pricing information. For example, the pricing information may be obtained from pricing sheets from a website associated with the selected pharmacy 120a-n. The pricing sheets can include cash cost available to any patient 115 who is not utilizing a payor (e.g., insurance company, PBM, etc.) for coverage. With a cash cost for a drug or product, the patient payable amount may be the entire cash cost while a payor may have zero cost. Alternatively, the pricing sheets can also include costs for situations where a payor is being utilized by the patient 115 for at least partial coverage. These costs can show a total cost, as well as an apportionment for a patient payable amount and another amount payable by a payor 125. In yet another alternative, the direct pricing information can also be available from a payor 125 or from a service provider. For example, the service provider computer 204 and/or virtual pharmacy module 205 may have direct pricing information stored in a database 242 for ready access. The direct pricing information may have been received from a pharmacy 120a-n, a payor 125, or another entity. It will be appreciated that the direct pricing information can include the pricing sheets described herein, or other information utilized to determine pricing. For example, if the pricing information is received from a payor 125, it may include a contracted total amount payable to the pharmacy 120a-n, as well as information utilized in apportioning the contracted amount between the patient 115 and the payor 125. It will be appreciated that many variations of direct pricing information are available without departing from example embodiments of the invention.

Following block 725, processing may proceed to block 765, where a determination is made as to whether costs or pricing needs to be determined for any additional pharmacy locations. If so, processing may return to block 705, where another pharmacy or pharmacy location may be selected.

On the other hand, block 720 may determine that direct pricing information is not available for the selected pharmacy 120a-n, and processing may proceed to block 730. Block 730 may determine whether historical pricing information is available for filling the prescription at the selected pharmacy 120a-n. In an example embodiment of the invention, the service provider computer 204 and/or virtual pharmacy module 205 may have assisted a prior patient in filling the same prescribed drug or product at the same selected pharmacy 120a-n in accordance with one or more services of a virtual pharmacy. Accordingly, a prior virtual pharmacy transaction record may be available showing costs (e.g., total costs, patient payable costs, payor costs) that were previously determined in accordance with the one or more services of the virtual pharmacy. Likewise, the historical pricing information may be available from prior prescription claim transaction records. For example, the service provider computer 204 or another service provider may have previously participated in a prescription claim transaction involving the same drug or product, selected pharmacy 120a-n, and/or payor 125. Accordingly, these prescription claim transaction records may be historical pricing information available for purposes of determining cost or pricing of filling one or more drugs or products at a pharmacy 120a-n. In an example embodiment of the invention, block 730 may likewise confirm that sufficient prescription claim transaction records are available and/or that the available prescription claim transaction records are within a predefined time period (e.g., within the last month, 2 weeks, 7 days, etc.). Accordingly, if one or more prior prescription transaction records are available, then historical pricing information may be available at block 730.

If historical pricing information is available at block 730, then processing may proceed to block 735. At block 735, the service provider computer 204 and/or virtual pharmacy module 205 may obtain cost or pricing information using the available historical pricing information. In an example embodiment of the invention, the historical pricing information may comprise virtual pharmacy transaction records or prescription claim transaction records, which may be the same or different in accordance with example embodiments of the invention. These stored transaction records may be obtained from a database 242 or another data storage associated with service provider computer 204 or another computer. Table I below shows example transaction records that could be virtual pharmacy transaction records or prescription claim transaction records, according to an example embodiment of the invention.

TABLE I

| | Payor ID | Pharmacy | | | | Patient | |
|---|---|---|---|---|---|---|---|
| | (e.g., | ID (e.g., | Quantity | Drug or | Total | Payable | |
| Record I | BIN/PCN) | NPI code) | Dispensed | Product | Cost | Amount | Date |
| Record #1 | Payor #1 | Pharm. 1 | 90 | Drug A | $60 | $10 | MM/DD/YY |
| Record #2 | Payor #2 | Pharm. 2 | 90 | Drug A | $38 | $20 | MM/DD/YY |
| Record #3 | Payor #3 | Pharm. 3 | 30 | Drug A | $10 | $0 | MM/DD/YY |
| Record #4 | Payor #4 | Pharm. 4 | 30 | Drug B | $25 | $5 | MM/DD/YY |
| . . . | | | . . . | . . . | . . . | | . . . |
| Record #n | Payor #2 | Pharm. 3 | 7 | Drug N | $40 | $15 | MM/DD/YY |

At block 735, the cost data may be obtained from analyzing the prescription claim transaction records involving the same drug or product, selected pharmacy 120a-n, and/or payor 125. In an example embodiment of the invention, the prescription claim records analyzed may be within a predetermined time frame to ensure that more recent transaction records are being utilized. In some example embodiments, only the most recent matching transaction records may be analyzed to obtain cost data for filling a prescription at a selected pharmacy 120a-n. In another example embodiment, there may need to be at least a predetermined number of matching transaction records available to obtain cost data for filling a prescription at a selected pharmacy 120a-n (e.g., to confirm that the same cost data is present across multiple records).

Once the transaction records have been obtained at block 735, the cost data may be obtained. For example, one or more transaction records can indicate a total cost for a patient (associated with a particular payor) filling a prescription at a particular pharmacy 120a-n. Likewise, the transaction records can specifically identify an amount payable by the patient 115 or another amount payable by the payor.

Following block 735, processing may proceed to block 765, where a determination is made as to whether costs or pricing needs to be determined for any additional pharmacy locations. If so, processing may return to block 705, where another pharmacy or pharmacy location may be selected.

On the other hand, block 730 may determine that historical pricing information is not available, and processing may proceed to block 740. Block 740 may determine whether industry pricing is available for the requested drug or product. For example, the service provider computer 204 and/or the virtual pharmacy module 205 may have access to an average wholesale price (AWP) for a particular drug or product, a wholesale acquisition cost (WAC), or other industry pricing. These industry pricing figures may be published by First Data Bank (FDB), Thomson Reuters, or another similar data provider. The industry pricing figures may be obtained on an as-needed basis, or on a periodic basis, and may be available in data storage such as from a database 242 or from a network computer.

If block 740 determines that industry pricing is available for the requested drug or product, then processing may proceed to block 745. Block 745 may include obtaining cost data from the available industry pricing. In some example embodiments of the invention, it will be appreciated that industry pricing figures may be helpful in estimating total costs at one or more retail pharmacies. For example, a retail price can be estimated as a certain percentage (e.g., 10%) above AWP. However, because the industry pricing figures are averages or rough estimates, it may not provide the granularity for comparing total costs across retail pharmacies. Instead, the industry pricing figures may be helpful in comparing retail pharmacies to non-retail pharmacies such as one or more mail-order pharmacies, according to an example embodiment of the invention.

Following block 745, processing may proceed to block 765, where a determination is made as to whether costs or pricing need to be determined for any additional pharmacy locations. If so, processing may return to block 705, where another pharmacy or pharmacy location may be selected.

On the other hand, block 740 may determine that the industry pricing is not available, and processing may proceed to block 750. Block 750 may determine whether any other price or cost determination method is available for determining the price or cost of filling a prescription at the selected pharmacy 120a-n. For example, an alternative price or cost determination method may include contacting another data aggregator to inquire about the cost of filling a prescription drug or product at a selected pharmacy 120a-n. If block 750 determines that alternate pricing is available, then processing may proceed to block 755, where the alternate price or cost determination method may be executed to determine the price or cost of filling the prescription at the selected pharmacy 120a-n. Following block 755, processing may proceed to block 765, where a determination is made as to whether costs or pricing needs to be determined for any additional pharmacies or pharmacy locations 120a-n. If so, processing may return to block 705, where another pharmacy or pharmacy location 120a-n may be selected.

On the other hand, block 750 may determine that alternate pricing is not available for the selected pharmacy 120a-n, and processing may proceed to block 760, where a determination may be made that the cost data cannot be determined for the selected pharmacy 120a-n.

Following block 755 or block 760, processing may proceed to block 765, where a determination is made as to whether costs or pricing needs to be determined for any additional pharmacy locations 120a-n. If so, processing may return to block 705, where another pharmacy or pharmacy location 120a-n may be selected.

On other hand, if no additional pharmacy locations are determined at block 765, then processing may proceed to block 770. Block 770 may determine whether the costs or pricing needs to be evaluated based upon another payor 125. For example, in some example embodiments, the negotiated costs may be different depending upon which payor 125 the patient 115 may be associated with. On the other hand, if block 770 determines that the costs or pricing does not need to be evaluated based upon another payor 125, then processing may terminate, and processing for the example process 700 may be complete.

It will be appreciated that many variations of the example process 700 may be available in accordance with example embodiments of the invention.

FIGS. 8-10 illustrate example processes for determining patient payable amounts, according to example embodiments of the invention. Any of the processes of FIGS. 8-10 may be utilized as an example implementation for determining a patient payable amount in accordance with the cost optimization of block 435 of FIG. 4. It will be appreciated, however, that many variations of the example processes of FIGS. 8-10 are available without departing from example embodiments of the invention. In some example embodiments of the invention, the patient payable amounts can be determined as part of the process 700 of FIG. 7.

Turning now more particularly to FIG. 8, there is illustrated an example process 800 for determining respective patient payable amounts for filling a prescription at one or more dispensing pharmacies 120a-n, according to an example embodiment of the invention.

At block 802, a payor 125 can be selected from one or more payors 125 available for the patient. The one or more payors 125 can include a payor that is currently providing coverage to a patient 115, or a payor that is not currently providing coverage for the patient 115, but that the patient 115 may consider enrolling with. The one or more payors 125 can also include the lack of a payor, as with a patient 115 who is a cash customer. The selection of a payor may be necessary because the patient payable amounts for filling a prescription at a pharmacy 120a-n may differ depending on which payor is selected. For example, the patient payable amount may differ depending on a payor-negotiated cost with a pharmacy 120a-n, according to an example embodiment of the invention.

Having selected a payor at block 802, processing may proceed to block 805, where a pharmacy location may be selected. At block 805, there may be one or more pharmacies or pharmacy locations for which associated costs or prices for filling a prescription need to be determined. The list of one or more pharmacies or pharmacy locations may have been determined, for example, from block 430 in FIG. 4, according to an example embodiment of the invention. At block 805, one of the pharmacies or pharmacy locations may be selected for purposes of determining a patient payable amount for filling the prescription at the selected pharmacy.

Following block 805 is block 810. At block 810, a percentage of the total price or cost of the drug or product may be obtained. It will be appreciated that this total price or cost may have been determined, for the selected payor and/or pharmacy location, in accordance with the example process 700 of FIG. 7. Once the total price or cost has been determined, then a percentage of the total price or cost may be calculated, for example, by multiplying the specified percentage by the total price or cost. The calculated percentage amount may be used as a basis for determining a patient payable amount. It will be appreciated that this percentage used in determining the calculated percentage amount may be set or specified by a payor or another entity such as a service provider, an employer associated with the patient 115, or the like. As an example, the payor may have included a specified percentage for determining the calculated percentage amount, and the specified percentage may differ depending upon the healthcare plan that the patient 115 is enrolled in.

In some example embodiments, the calculated percentage amount at block 810 may be used as the patient payable amount. However, in some embodiments, the calculated percentage amount at block 810 may be modified, perhaps subject to minimum or maximum patient payable amounts, for purposes of the patient payable amount. The minimum or maximum patient payable amounts may be set or specified by a payor or another entity such as a service provider, an employer associated with the patient 115, or the like.

For example, block 815 may determine whether the calculated percentage amount is less than a minimum patient payable amount. It will be appreciated that the minimum patient payable amount can be set to zero, which effectively results in there being no minimum patient payable amount, according to an example embodiment of the invention. If the calculated percentage amount is less than a minimum patient payable amount, then processing may proceed to block 820, where the patient payable amount may be set to be the minimum patient payable amount.

On the other hand, block 815 may determine that the calculated percentage amount is not less than the minimum patient payable amount, and processing may proceed to block 825. Block 825 may determine whether the calculated percentage amount exceeds a maximum patient payable amount. It will be appreciated that the maximum payable amount can be set to a high number or infinite value, which effectively results in there being no maximum patient payable amount, according to an example embodiment of the invention. If the calculated percentage amount is greater than the maximum patient payable amount, then processing may proceed to block 830, where the patient payable amount may be set to the maximum patient payable amount.

On the other hand, block 825 may determine the calculated percentage amount is less than the maximum patient payable amount. In this case, the calculated percentage amount may fall between the minimum and maximum patient payable amounts, and processing may proceed to block 835. At block 835, the patient payable amount may be set to be equal to the calculated percentage amount.

Following block 835 is block 840. Block 840 can also be reached following block 820 or block 830. Block 840 may determine whether a patient payable amount needs to be determined for any additional pharmacy locations. If so, processing may return to block 805, where another pharmacy or pharmacy location may be selected.

On other hand, if no additional pharmacy locations are determined at block 840, then processing may proceed to block 845. Block 845 may determine whether the patient payable amount needs to be evaluated based upon another payor. For example, in some example embodiments, the negotiated costs may be different depending upon which payor the patient may be associated with. If block 845 determines that the patient payable amount needs to be evaluated based upon another payor, then processing may return to block 802, where another payor may be selected. On the other hand, if block 845 determines that the costs or pricing does not need to be evaluated based upon another payor, then processing may terminate, and processing for the example process 800 may be complete.

It will be appreciated that many variations of the example process 800 may be available in accordance with example embodiments of the invention.

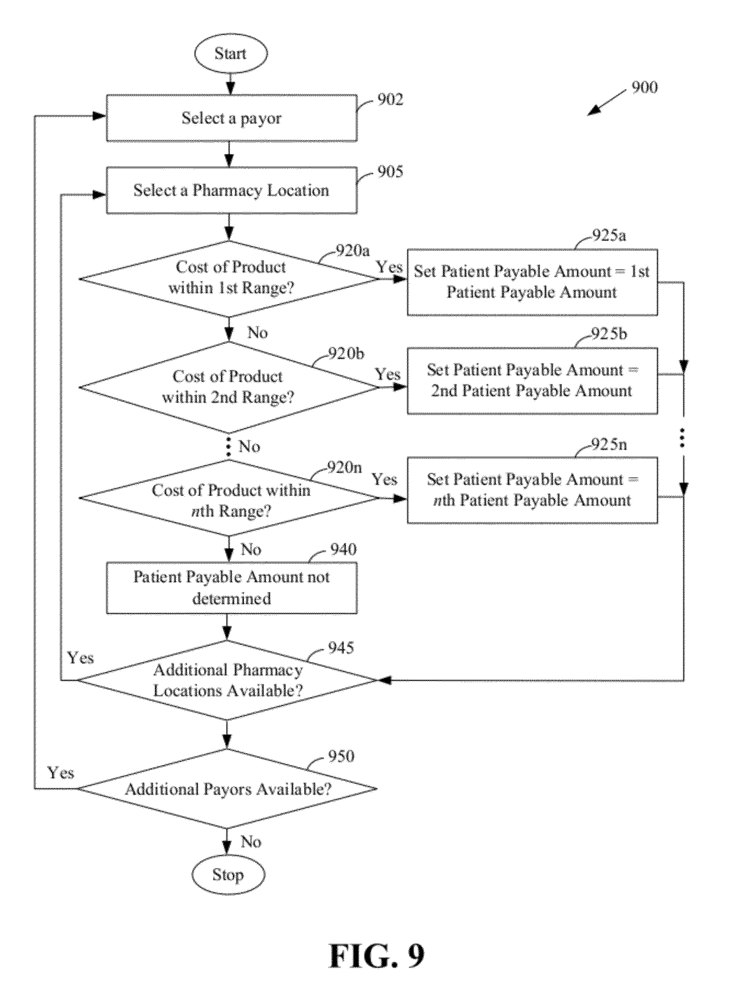

FIG. 9 illustrates another example process 900 for determining respective patient payable amounts for filling a prescription at one or more pharmacies 120a-n, according to an example embodiment of the invention. In general, according to the example process 900, there may be two or more tiers of patient payable amounts that are based upon the total price or cost at a dispensing pharmacy 120a-n.

At block 902, a payor can be selected from one or more payors 125 available for the patient 115, as similarly described herein. Having selected a payor 125 at block 902, processing may proceed to block 905, where a pharmacy location 120a-n may be selected. At block 905, there may be one or more actual/dispensing pharmacies or pharmacy locations 120a-n for which associated patient payable costs or prices for filling a prescription need to be determined.

Following block 905 are a plurality of blocks 920a-n. In particular, each of blocks 920a-n may be operative to determine whether the total cost of the drug or product is within certain ranges. Each block 920a-n may correspond to a particular tier of pricing for patient payable amounts. As an example, if the total cost of the drug or product is within a first range according to block 920a, then processing may proceed to block 925a, where the patient payable amount may be set to a first predefined patient payable amount. On the other hand, if the cost of the drug or product is within a second range according to block 920b, then processing may proceed to block 925b, where the patient payable amount may be set to a second predefined patient payable amount. Similarly, if the cost of the drug or product is within an nth range according to block 920n, then processing may proceed to block 925n, where the patient payable amount may be set to an nth predefined patient payable amount. It will be appreciated that the number of blocks 920a-n may be based upon the number of pricing ranges and/or tiers for patient payable amounts desired.

Following any of blocks 925a-n is block 945. Block 945 can be also be reached from block 940 if the total price or cost of the drug or product is outside of the specified ranges of any of blocks 920a-n, which is expected to be an uncommon situation, according to an example embodiment of the invention. Block 945 may determine whether a patient payable amount needs to be determined for any additional pharmacy locations 120a-n. If so, processing may return to block 905, where another pharmacy or pharmacy location 120a-n may be selected.

On other hand, if no additional pharmacies or pharmacy locations 120a-n are determined at block 945, then processing may proceed to block 950. Block 950 may determine whether the patient payable amount needs to be evaluated based upon another payor 125. For example, in some example embodiments, the negotiated costs may be different depending upon which payor 125 the patient 115 may be associated with. If block 950 determines that the patient payable amount needs to be evaluated based upon another payor 125, then processing may return to block 902, where another payor 125 may be selected. On the other hand, if block 950 determines that the costs or pricing does not need to be evaluated based upon another payor 125, then processing may terminate, and processing for the example process 900 may be complete.

It will be appreciated that many variations of the example process 900 may be available in accordance with example embodiments of the invention.

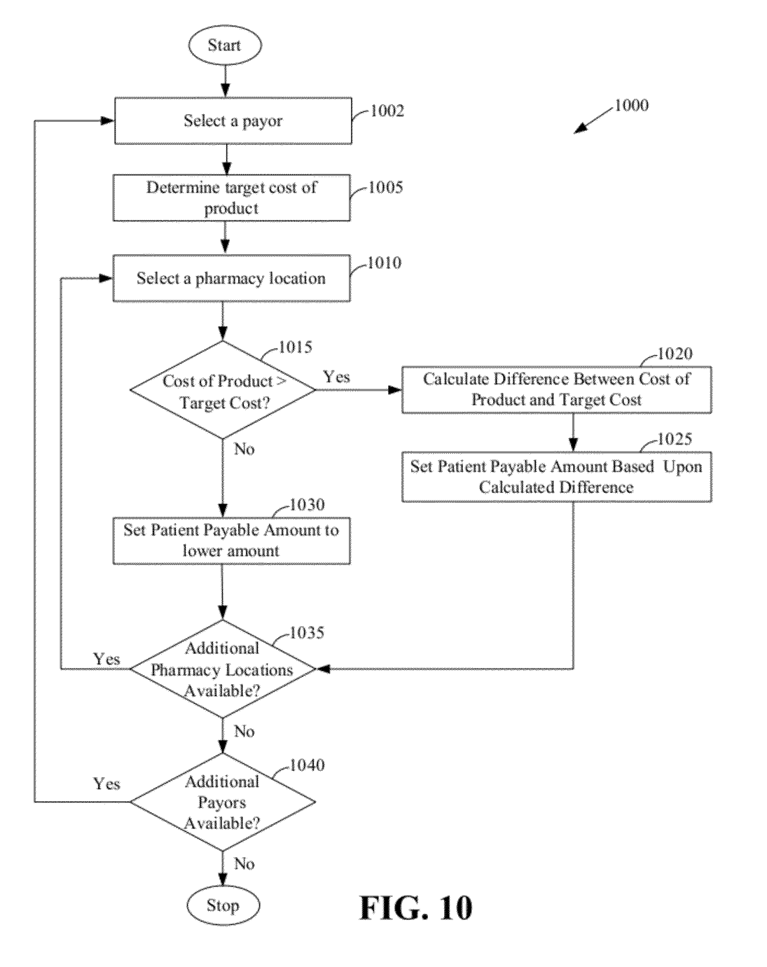

FIG. 10 illustrates another example process 1000 for determining respective patient payable amounts for filling a prescription at one or more dispensing pharmacies 120a-n, according to an example embodiment of the invention. In general, according to the example process 1000, the patient payable amounts can be based upon a target or desired price or cost of a drug or product.

At block 1002, a payor can be selected from one or more payors 125 available for the patient 115, as similarly described herein. Having selected a payor 125 at block 902, processing may proceed to block 1005, where a target cost of the drug or product can be determined. This target cost can globally apply to all payors 125, or it may be specific to a particular payor 125. Likewise, the target cost may be dynamically determined based upon the respective total costs of the drug or product that were previously determined, perhaps in accordance with the example process 700 of FIG. 7. For example, the target cost can be the lowest cost available at an actual/dispensing pharmacy 120a-n available for the patient 115. Accordingly, the target cost can be based upon market dynamics/market pricing and the availability of lower costs at one or more pharmacies 120a-n. In another example embodiment of the invention, the target cost can be based upon an industry standard cost such as an AWP, a WAC, or the like. Likewise, the target cost can also be specified by a payor or another entity such as an employer, a service provider, or the like. In an example embodiment of the invention, the patient payable amount may be set based upon the target cost to drive the total cost of filling the prescription down towards the target cost.

Following block 1005 is block 1010, where a pharmacy location 120a-n may be selected. At block 1010, there may be one or more actual/dispensing pharmacies 120a-n or pharmacy locations for which associated patient payable costs or prices for filling a prescription need to be determined.

Following block 1010 is block 1015. Block 1015 may determine whether the total cost or price of the drug or product at the particular pharmacy location 120a-n is greater than the target cost. If the cost of the product is greater than the target cost, then processing may proceed to block 1020, where the difference between the total cost of the drug or product and the target cost may be calculated. Following block 1020 is block 1025. At block 1025, the patient payable amount may be set based upon this calculated difference. For example, the patient 115 may be responsible for paying for all of the calculated difference or only a percentage or portion of the calculated difference. In addition to paying for at least a portion of the calculated difference, there may be one or more predetermined amounts (e.g., a base patient payable amount) added to provide the total patient payable amount, according to an example embodiment of the invention.

On the other hand, block 1015 may determine that the total cost or price of the drug or product at the particular pharmacy location 120a-n is not greater than the target cost. In this case, processing may proceed to block 1030. At block 1030, the patient payable amount can be set to a lower amount. The lower amount can be a predetermined amount, a zero amount, or a variable amount. For example, the lower amount can be a variable amount that is based upon a difference between the price or cost of the product and the target cost such that a larger difference may result in a lower patient responsible amount.

Following block 1030 is block 1035. Block 1035 may also be reached following block 1025. Block 1035 may determine whether a respective patient payable amount needs to be determined for any additional pharmacy locations 120a-n. If so, processing may return to block 1010, where another pharmacy or pharmacy location may be selected.

On other hand, if no additional pharmacy locations 120a-n are determined at block 1035, then processing may proceed to block 1040. Block 1040 may determine whether any other patient payable amount needs to be evaluated or determined based upon another payor 125. For example, in some example embodiments, the negotiated costs may be different depending upon which payor 125 the patient 115 may be associated with. If block 1040 determines that a patient payable amount needs to be evaluated or determined based upon another payor 125, then processing may return to block 1002, where another payor 125 may be selected. On the other hand, if block 1040 determines that the costs or pricing does not need to be evaluated based upon another payor 125, then processing may terminate, and processing for the example process 1000 may be complete.

It will be appreciated that many variations of the example process 1000 may be available in accordance with example embodiments of the invention.

Identifying Incentives

FIG. 11 illustrates an example process 1100 for determining or identifying any applicable incentives for filling a prescription at one or more pharmacies, according to an example embodiment of the invention. The example process 1100 may be an example implementation of block 445 of FIG. 4, although many variations of the example process 1100 are available without departing from example embodiments of the invention. The example process 1100 may be implemented as computer-executable instructions that are executed by a service provider computer 204 and/or a virtual pharmacy module 205, or any other similar computer.

Turning now to block 1105, the eligible incentive or penalty types may be identified. The eligible incentive or penalty types may be based upon patient enrollment in one or more incentive healthcare programs. These incentive healthcare programs can be sponsored by an employer associated with the patient 115, a payor associated with the patient 115, a pharmacy 120a-n and/or virtually any entity that wishes to incentivize a patient 115 to pick a particular pharmacy for filling a prescription for a drug or product. As an example, a self-insured employer or a payor may wish to direct a patient 115 to select a pharmacy 120a-n that is a low-cost provider of a drug or product. Likewise, a particular pharmacy 120a-n may wish to incentivize a patient to fill a prescription at that pharmacy. Many entities can sponsor the incentives (or penalties) without departing from example embodiments of the invention. In an example embodiment of the invention, the incentives (or penalties) can be of a variety of types, including financial incentives, points, and/or social incentives.

Following block 1105 is block 1110. Block 1110 can determine whether any applicable financial incentives (or penalties) apply for filling a prescription at any of the available pharmacy locations 120a-n. If so, then processing may proceed to block 1115, where a respective financial incentive (or penalty) can be calculated for one or more pharmacy locations 120a-n. As an example, a financial incentive can include one or more of the following:
A financial incentive amount that will be applied directly to reduce a patient payable amount at a point of payment for filling a prescription at a pharmacy 120a-n;
A financial incentive amount that will be credited to (or debited from) an account of the patient 115 responsive to the patient filling a prescription at a pharmacy 120a-n; and/or
A financial incentive amount that will otherwise reduce (or increase) a liability of the patient 115 upon filling a prescription at a pharmacy 120a-n.

The amount of the financial incentive can be set in a variety of ways. In general, the amount of the financial incentive (or penalty) may be set to encourage patient behavior to obtain a desired outcome. As an example, the financial incentive (or penalty) may be set to encourage a patient 115 to select a lower-cost pharmacy 120a-n for filling the prescription. To do so, a financial incentive can be available for filling a prescription at one or more lower-cost pharmacies 120a-n. Alternatively, a financial penalty can be applied for filling a prescription at one or more higher-cost pharmacies 120a-n.

It will be appreciated that the amount of the financial incentives or penalties can be calculated in a variety of ways. According to an example embodiment of the invention, the financial incentive can be a predetermined or fixed amount specified by a sponsor associated with the financial incentive. Likewise, the predetermined or fixed amount can be based upon the drug or product specified by the prescription. In another example embodiment, the financial incentive can be a variable amount that is based upon the total cost of filling the prescription at a pharmacy 120a-n, or a variation thereof. For example, the variable amount can be calculated based upon an expected cost savings, which may be a difference between the total cost of the drug or product and a target cost, or a median or mean cost of the drug or product across other available pharmacies. The financial incentive amount may also be based upon whether the patient has accepted a previously offered financial incentive for the same drug or product and/or the same pharmacy location 120a-n. Likewise, the financial incentive may be based upon whether the patient has filled any prescription at a particular pharmacy location 120a-n within a time frame. As an example, if the patient previously received a drug or product at the particular pharmacy location 120a-n, then there may not be any financial incentive needed to incentivize the patient to visit that particular pharmacy location 120a-n.

If no financial incentives (or penalties) are available at block 1110, then processing may proceed to block 1120. Block 1120 may determine any applicable points that can be accumulated (or debited) for filling a prescription at one or more pharmacy locations 120a-n. In an example embodiment of the invention, the points can be similar to loyalty points that can be redeemed, for example, for one or more free or reduced-price products, services, vouchers, coupons, or the like. In an example embodiment of the invention, these products or services can be healthcare products or services, as well as non-healthcare products or services.

If block 1120 determines that any applicable points can be accumulated (or debited), then processing may proceed to block 1125. Block 1125 may determine the number of points that will be accumulated (or debited) for filling a prescription at one or more pharmacies 120a-n. As similarly described above, the number of points accumulated (or debited) may be set in a way to incentivize a patient 115 to fill a prescription at a lower-cost pharmacy 120a-n. Accordingly, a patient may earn more points for filling a prescription at a lower-cost pharmacy 120a-n. On the other hand, a patient 115 may also lose points for filling a prescription at a higher-cost pharmacy 120a-n. Likewise, a patient 115 may need more or less incentive points based upon whether the patient 115 has previously filled a prescription at a lower-cost pharmacy 120a-n or whether the patient accepted a previously offered incentive for a lower-cost pharmacy 120a-n. For example, if a patient was previously offered an incentive for a lower-cost pharmacy 120a-n, but chose to have a prescription filled at a higher cost pharmacy 120a-n, then it may be desirable to increase an amount of points incentive for filling at a lower-cost pharmacy 120a-n, or otherwise provide a higher points penalty for filling a prescription at a higher-cost pharmacy 120a-n, according to an example embodiment of the invention. In an example embodiment of the invention, the number of points can also be based upon an expected cost savings, which may be a difference between the total cost of the drug or product and a target cost, or a median or mean cost of the drug or product across other available pharmacies 120a-n.

If no points are available at block 1120, then processing may proceed to block 1130. Block 1130 may determine whether any social incentives (or disincentives) are available for filling a prescription at one or more pharmacy locations 120a-n. In an example embodiment of the invention, the social incentives may be incentives that are associated with information that may be viewable by the patient's social group, friends, coworkers, peers, or the like.

If block 1130 determines that any social incentives (or disincentives) are available, then processing may proceed to block 1135. At block 1135, the social incentives (or disincentives) for filling a prescription at one or more pharmacies 120a-n can be determined. In this regard, there may be badges or other indicators that may be earned for filling a prescription at a lower-cost pharmacy 120a-n. These badges or other indicators may be available for display such that they are viewable by the patient's social group, friends, coworkers, peers, or the like. In an example embodiment of the invention, the badges or other indicators can be available for a social networking site like Facebook or an employer-sponsored website. In an example embodiment of the invention, the badges or other indicators can likewise indicate or represent an amount of savings that the patient has accumulated over a period of time by selecting a lower-cost pharmacy. The amount of savings can indicate a range of savings, or a specific amount of savings. The savings can be calculated based upon a difference between the actual cost of filling the prescription and a mean/median cost or another cost (e.g., the highest cost), according to an example embodiment of the invention.

If no social incentives are available at block 1130, then processing may proceed to block 1140. Block 1140 may determine whether any other incentives are available for filling a prescription at any of the available pharmacies 120a-n. If any other incentives are available, then processing may proceed to block 1145, where any other incentives may be determined for filling a prescription at one or more pharmacies 120a-n.

It will be appreciated that many variations of the example process 1100 of FIG. 11 are available without departing from example embodiments of the invention.

Financial Processing

FIG. 12 illustrates a process 1200 for example financial processing, according to an example embodiment of the invention. In an example embodiment, the example process 1200 can be an example implementation for the example block 465 of FIG. 4, according to an example embodiment of the invention.

The process 1200 may begin with block 1202. Block 1202 may determine whether prescription claim adjudication should be performed prior to delivering a prescription to a selected dispensing pharmacy 120a-n, according to an example embodiment of the invention. If prescription claim adjudication should be performed, then processing may proceed to block 1203.

At block 1203, the prescription claim adjudication may be facilitated by the service provider computer 204 and/or virtual pharmacy module 205. To facilitate the prescription claim adjudication, the service provider computer 204 and/or virtual pharmacy module 205 may deliver a prescription claim 330 to the financial processing computer 208 (e.g., claims processor computer). The prescription claim 330 may be in accordance with a version of a National Council for Prescription Drug Programs (NCPDP) Telecommunication Standard, although other standards may be utilized as well. The prescription claim 330 may include a BIN Number and/or a combination of a BIN Number and Processor Control Number (PCN) for identifying a particular claims processor computer or payor, such as the financial processing computer 208, as a destination for the prescription claim 330. In addition, the prescription claim 330 may also include information relating to the patient, payor, prescriber, healthcare provider, and/or the prescribed drug or product. As an example, the prescription claim 330 received by the financial processing computer 208 may include one or more of the following information:

Payer ID/Routing Information for each identified insurer or payor
BIN Number and Processor Control Number (PCN) that designates an intended destination of the prescription claim 330

Patient Information
Name (e.g., Patient Last Name, Patient First Name, etc.)
Date of Birth of Patient
Age of Patient
Gender
Patient Address (e.g., Street Address, Zip Code, etc.)
Patient Contact Information (e.g., Patient Telephone Number)
Patient ID or other identifier

Insurance/Coverage Information
Cardholder Name (e.g., Cardholder First Name, Cardholder Last Name)
Cardholder ID and/or other identifier (e.g., person code)

Provider Information
Prescriber Information
Primary Care Provider ID or other identifier (e.g., National Provider Identifier (NPI) code)
Primary Care Provider Name (e.g., Last Name, First Name)
Prescriber ID or other identifier (e.g., NPI code, DEA number)
Prescriber Name (e.g., Last Name, First Name)
Prescriber Contact Information (e.g., Telephone Number, Fax number, Email Address, etc.)

Dispensing Pharmacy information
Pharmacy Identifier (e.g., NPI code)
Pharmacy Contact Information (e.g., Telephone Number, Fax number, Email Address, etc.)

Claim Information
Drug or product information (e.g., National Drug Code (NDC))
Prescription/Service Reference Number
Date Prescription Written
Quantity Dispensed
Number of Days Supply
Diagnosis/Condition
Pricing information for the drug or product (e.g., network price, Usual & Customary price)

Date of Service.

It is appreciated that the aforementioned information is provided for illustrative purposes, and that any number of fields can be included in a prescription claim 330 as desired or required. Moreover, one or more of the aforementioned fields may be stored locally by the service provider computer 204, such as in a database 242, and be retrieved based on a unique identifier (or combination of information) transmitted in the prescription claim 330.

Thus, the service provider computer 204 can communicate the prescription claim 330 to an appropriate financial processing computer 208 for adjudication or other benefits processing. According to an example embodiment, the service provider computer 204 may utilize at least a portion of the information included in the prescription claim 330, such as a BIN/PCN or other destination ID, to determine the appropriate financial processing computer 208 to route the prescription claim 330 to. The service provider computer 204 and/or virtual pharmacy module 205 may also include a routing table, perhaps stored in memory, for determining which financial processing computer 208 to route the prescription claim 330 to.

The financial processing computer 208 can generate an adjudication response 332 indicating a result of processing or adjudicating the prescription claim 330. The adjudication response 332 can indicate whether the claim request 330 was paid (approved) or rejected by an insurer or payor associated with the financial processing computer 208. If paid or approved, the adjudication response 332 may include financial coverage information such as a covered amount and/or the patient pay amount (e.g., co-pay amount, co-insurance amount, etc.). On the other hand, if rejected, the adjudication response 332 may include one or more reasons for denial of coverage by the insurer or payor associated with the financial processing computer 208. The adjudication response 332 can be provided from financial processing computer 208 to the service provider computer 204.

Following the adjudication at block 1203, processing may proceed to block 1205. Block 1205 can also be reached if block 1202 determines that no prescription claim adjudication or processing is needed prior to delivering the electronic prescription to the pharmacy. At block 1205, the total cost of the drug or product can be determined. If block 1205 was reached from block 1203, then the total cost payable to the selected pharmacy 120a-n may be determined from the claim request 330 and/or the adjudication response 332. Alternatively, the total cost of the drug or product could have previously been determined in accordance with an example process 700 of FIG. 7, in which case block 1205 may be optional, according to an example embodiment of the invention.

Following block 1205 is block 1210. Block 1210 may determine the portion of the total cost to be paid by the patient. In an example embodiment of the invention, the total cost to be paid by the patient may be a patient payable amount provided for in an adjudication response 332. Alternatively, a patient payable amount may have been previously determined in accordance with an example process 800, 900, 1000 of any of respective FIGS. 8, 9, 10, in which case block 1210 may be optional, according to an example embodiment of the invention.

Following block 1210 is block 1215. Block 1215 may determine whether the patient payable amount is greater than zero. If not, then processing may proceed to block 1220, where a determination is made that no patient payment is required for filling a prescription for the requested drug or product at the selected pharmacy 120a-n.

On the other hand, block 1215 may determine that the patient payable amount is greater than zero, and processing may proceed to block 1225. Block 1225 may determine whether the patient financial information is available. As an example, the patient financial information may identify a financial instrument for use in covering payment of at least a portion of the patient payable amount. Accordingly, the patient financial information can include information associated with a deposit account (e.g., checking account, saving account, etc.), credit/debit card account, flexible spending account (FSA)/healthcare savings account (HSA), or other monetary transaction account (e.g., PayPal account, mobile payment account, etc.). In this regard, the financial information can include any of the following:
a cardholder ID (e.g., for a credit/debit card);
card security code and/or expiration date (e.g., for a credit/debit card);
an account number (e.g., for a deposit account, FSA/HSA); and/or
a routing number (e.g., for a deposit account).

In some embodiments, the patient financial information may be available in a stored record associated with the patient 115. The stored record may have been provided when the patient 115 registered for one or more services with the virtual pharmacy, or otherwise provided or updated financial information at an Internet portal/website sponsored by a service provider, a healthcare provider, a financial processor, and the like. In other embodiments, the patient financial information may have been provided by the patient 115 when delivering the prescription 302 to the service provider computer 204 and/or virtual pharmacy module 205. In yet other embodiments, the patient financial information may be received in response to a request for patient financial information that is delivered to the patient device/computer 206 from the service provider computer 204 and/or virtual pharmacy module 205.

If the patient financial information is not available at block 1225, then processing may proceed to block 1230. At block 1230, the service provider computer 204 and/or the virtual pharmacy module 205 may perform one or more processes to obtain the patient financial information. According to one example embodiment, the service provider computer 204 and/or the virtual pharmacy module 205 may deliver a request for patient financial information to the patient device/computer 206. The request can also indicate a patient payable amount to be paid. Upon receipt of the request, the patient device/computer 206 can display or present a message (e.g., via a mobile application software, text message, etc.) identifying the patient payable amount and requesting patient payment information from the patient 115. The patient 115 can then use the patient device/computer 206 to enter or provide the appropriate payment information to direct a payment from a financial instrument associated with the patient 115. In an example embodiment of the invention, the payment information can include, for example, a cardholder ID (and/or expiration date and security code) or an account number (and/or routing number). In some embodiments, the payment information can be provided on a payment authorization form that provides authorization to a recipient (e.g., service provider and/or selected pharmacy) to charge a patient payable amount to the financial instrument identified by the payment authorization form. This payment authorization form can also be received by the service provider computer 204 and/or the virtual pharmacy module 205 from a facsimile/electronic device 311 of the patient 115.

Alternatively, at block 1230, the service provider computer 204 and/or the virtual pharmacy module 205 can contact another entity to obtain the patient financial information. For example, the service provider computer 204 and/or virtual pharmacy module 205 may communicate with another computer or database to obtain the patient financial information. As an example, an employer may be associated with a computer that can provide HSA/FSA information for a patient 115 in response to a request identifying a patient 115. As another example, a financial entity can likewise provide information regarding a financial instrument of the patient 115 in response to a request identifying the patient. Following block 1230, processing may return to block 1225 to confirm that all of the needed patient financial information is available.

If block 1225 determines that all of the patient financial information is available, then processing may proceed to block 1235. Block 1235 may determine whether the patient financial information is to be delivered to a financial processor for processing. It will be appreciated that block 1235 may determine whether the patient financial information is to be delivered to a financial processor based upon stored preferences, which may be available from database 242. For example, a dispensing pharmacy 120a-n that the prescription 304 is being delivered to may have specified preferences regarding whether financial processing with a financial processor should be directed by the service provider computer 204 and/or the virtual pharmacy module 205. In this regard, the pharmacy 120a-n can decide whether it will handle the financial processing or whether the service provider computer 204 and/or the virtual pharmacy module 205 can direct the financial processing. Likewise, the patient 115 may also specify preferences, perhaps at the time of providing the patient financial information, regarding whether it wishes for the financial processing to occur before the patient 115 visits the pharmacy 120a-n to pick up the requested drug or product.

If block 1235 determines that the patient financial information is to be delivered to a financial processor, then processing may proceed to block 1245. At block 1245, the service provider computer 204 and/or the virtual pharmacy module 205 can deliver a financial transaction request 334 to the financial processing computer 208 for processing. The financial transaction request 334 include patient financial information, including identification of a financial instrument of the patient 115 as well as a patient payable amount to debit or apply to the financial instrument. As an example, the financial instrument can be a deposit account, a credit/debit card account, FSA/HSA, or other monetary transaction account (e.g., PayPal, mobile payments, etc.). In an example embodiment of the invention, the financial transaction request 334 may be in a standard financial transaction format such one used for an Automated Clearing House (ACH) transaction or another electronic debit transaction (e.g., debit from a debit/credit card account, HSA/FSA, etc.).

Following block 1245 is block 1250. At block 1250, the financial processing computer 208 may be processed the financial transaction request 334. The financial processing computer 208 can deliver a financial transaction response 336 that indicates whether the patient payable amount was successfully debited from or applied to the financial instrument specified by the financial transaction request 336, according to an example embodiment of the invention. In this case, processing may then proceed to block 1255, where the result of the financial transaction processing may be prepared for delivery to the pharmacy 120a-n. As an example, information from the financial transaction request 334 and/or financial transaction response 336 can be prepared for delivery to the pharmacy computer 203 to inform the pharmacy 120a-n that financial processing has been directed along with the results of the processing. It will be appreciated that in some example embodiments, the financial processing may result in a deposit of the patient payable amount to an account of the pharmacy 120a-n. In another example embodiment, the financial processing may result in a deposit of the patient payable amount to an account of a service provider, which will in turn provide at least a portion of the collected patient payable amount to the pharmacy 120a-n.

On the other hand, if block 1235 determines that the patient financial information will not be delivered to a financial processor, then processing may proceed to block 1250. Block 1250 may determine whether any patient financial information is authorized to be delivered to the pharmacy 120a-n. The patient financial information may enable the pharmacy 120a-n to perform any required financial processing. Block 1250 may include obtaining preferences of the pharmacy 120a-n regarding whether it wishes to receive any patient financial information. Block 1250 may further include determining whether the patient 115 has authorized the service provider to provide the patient financial information to the pharmacy 120a-n.

If block 1250 determines that the patient financial information is authorized to be delivered to pharmacy 120a-n, then processing may proceed to block 1255. In this case, at block 1255, the service provider computer 204 and/or the virtual pharmacy module 205 may prepare the patient financial information for delivery to the pharmacy 120a-n. In an example embodiment of the invention, the patient financial information can be in the form of a payment authorization that authorizes the pharmacy 120a-n to charge or debit a patient responsible amount from a patient's financial instrument. An example payment authorization may be provided in a payment authorization form received from the patient 115, or it may be provided in a format prepared by the service provider computer 204 and/or the virtual pharmacy module 205. Indeed, different pharmacies may have different requirements for receiving payment authorizations.

Following block 1255, the example process 1200 of FIG. 12 may stop. It will be appreciated that many variations of the example process 1200 are available without departing from example embodiments of the invention.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Many modifications and other embodiments of the invention set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for determining patient pricing for one or more drugs or products, comprising:
receiving, by a non-dispensing virtual pharmacy comprising one or more computers, an electronic prescription associated with a patient, wherein the electronic prescription is associated with at least one drug or product prescribed for the patient;
determining, by the non-dispensing virtual pharmacy, a respective total price payable to each of the plurality of dispensing pharmacies for filling the prescription for the patient;
determining, by the non-dispensing virtual pharmacy based upon the determined respective total price, a respective patient payable amount for filling the prescription at each of the plurality of dispensing pharmacies; and
delivering, in real-time from the non-dispensing virtual pharmacy to a patient device, an identification of the plurality of dispensing pharmacies and the respective patient payment amount at each dispensing pharmacy.

2. The method of claim 1, wherein determining the respective patient payable amount for filling the prescription at each of the plurality of dispensing pharmacies comprises:
determining a target amount for the drug or product;
calculating a difference between the respective total price payable and the target amount; and
determining the respective patient payable amount based at least in part on the calculated difference.

3. The method of claim 2, wherein the target amount is one of (i) a predefined amount set by a payor, or (ii) an amount based upon an industry standard amount associated with the drug or cost.

4. The method of claim 3, wherein the industry standard amount is an average wholesale price (AWP) or a wholesale acquisition cost (WAC).

5. The method of claim 2, wherein the target amount is a lowest amount determined for any respective total price payable.

6. The method of claim 1, wherein determining the respective patient payable amount for filling the prescription at each of the plurality of dispensing pharmacies comprises:
calculating a percentage amount of the respective total price, wherein the respective patient payable amount is based at least in part on the calculated percentage amount.

7. The method of claim 6, wherein if the calculated percentage amount is less than a minimum amount, then the respective patient payable amount is set to the minimum amount, or if the calculated percentage amount is greater than a maximum amount, then the respective patient payable amount is set to the maximum amount.

8. The method of claim 1, wherein the electronic prescription is received in conjunction with information identifying a first payor of the patient, and wherein one or more of the determined respective total prices are available for the first payor.

9. The method of claim 8, wherein one or more of the determined respective total prices are available for a second payor different from the first payor, the second payor not currently associated with the patient.

10. The method of claim 1, further comprising:
receiving, from the patient device, a selection of one of the plurality of dispensing pharmacies; and
receiving, via the patient device, identification of a financial instrument for payment of the respective patient payment amount corresponding to the selected dispensing pharmacy.

11. A system, comprising:
at least one memory that stores computer-executable instructions;
at least one processor configured to access the at least one memory, wherein the at least one processor is further configured to execute the computer-executable instructions to:
receive an electronic prescription associated with a patient, wherein the electronic prescription is associated with at least one drug or product prescribed for the patient;
determine a respective total price payable to each of the plurality of dispensing pharmacies for filling the prescription for the patient;
determine, based upon the determined respective total price, a respective patient payable amount for filling the prescription at each of the plurality of dispensing pharmacies; and
deliver, in real-time to a patient device, an identification of the plurality of dispensing pharmacies and the respective patient payment amount at each dispensing pharmacy,
wherein the at least one memory and the at least one processor are associated with a non-dispensing virtual pharmacy.

12. The system of claim 11, wherein the at least one processor is configured to determine the respective patient payable amount for filling the prescription at each of the plurality of dispensing pharmacies by:
determining a target amount for the drug or product;
calculating a difference between the respective total price payable and the target amount; and
determining the respective patient payable amount based at least in part on the calculated difference.

13. The system of claim 12, wherein the target amount is one of (i) a predefined amount set by a payor, or (ii) an amount based upon an industry standard amount associated with the drug or cost.

14. The system of claim 13, wherein the industry standard amount is an average wholesale price (AWP) or a wholesale acquisition cost (WAC).

15. The system of claim 12, wherein the target amount is a lowest amount determined for any respective total price payable.

16. The system of claim 11, wherein the at least one processor is configured to determine the respective patient payable amount for filling the prescription at each of the plurality of dispensing pharmacies by:
calculating a percentage amount of the respective total price, wherein the respective patient payable amount is based at least in part on the calculated percentage amount.

17. The system of claim 16, wherein if the calculated percentage amount is less than a minimum amount, then the respective patient payable amount is set to the minimum amount, or if the calculated percentage amount is greater than a maximum amount, then the respective patient payable amount is set to the maximum amount.

18. The system of claim 11, wherein the electronic prescription is received in conjunction with information identifying a first payor of the patient, and wherein one or more of the determined respective total prices are available for the first payor.

19. The system of claim 18, wherein one or more of the determined respective total prices are available for a second payor different from the first payor, the second payor not currently associated with the patient.

20. The system of claim 11, wherein the at least one processor is further configured to execute the computer-executable instructions to:
receive, from the patient device, a selection of one of the plurality of dispensing pharmacies; and
receive, via the patient device, identification of a financial instrument for payment of the respective patient payment amount corresponding to the selected dispensing pharmacy.
